(19) United States
(12) Patent Application Publication
(10) Pub. No.: US 2021/0097044 A1
(43) Pub. Date: Apr. 1, 2021

(54) SYSTEMS AND METHODS FOR DESIGNING DATA STRUCTURES AND SYNTHESIZING COSTS

(71) Applicants: Stratos IDREOS, Cambridge, MA (US); Kostas ZOUMPATIANOS, Cambridge, MA (US); Brian HENTSCHEL, Cambridge, MA (US); Michael KESTER, Cambridge, MA (US)

(72) Inventors: Stratos IDREOS, Cambridge, MA (US); Kostas ZOUMPATIANOS, Cambridge, MA (US); Brian HENTSCHEL, Cambridge, MA (US); Michael KESTER, Cambridge, MA (US)

(21) Appl. No.: 17/050,202

(22) PCT Filed: Apr. 22, 2019
(86) PCT No.: PCT/US2019/028445

§ 371 Date: Oct. 23, 2020

Related U.S. Application Data
(60) Provisional application No. 62/662,512, filed on Apr. 25, 2018.

(51) Int. Cl. G06F 16/22; G06Q 10/10; G06F 16/28; G06F 16/21; G06N 20/00; G06N 5/04

(52) U.S. Cl. CPC G06F 16/22; G06Q 10/103; G06Q 10/101; G06N 5/04; G06F 16/21; G06N 20/00; G06F 16/285

(57) ABSTRACT

Various approaches for determining the operation cost of a computational workload that is executed on a computational apparatus and accesses data stored in a data structure include decomposing the data structure into multiple data layout primitives, each data layout primitive corresponding to a smallest, fundamental layout aspect of the data structure; decomposing the computational workload into multiple data access primitives, each data access primitive corresponding to a computational mechanism for accessing the data stored in the data structure; determining a hardware profile associated with the apparatus; and computing the operation cost of the computational workload on the apparatus based at least in part on the data layout primitives, the data access primitives, and the hardware profile.

### CROSS-REFERENCE TO RELATED APPLICATION

This application claims priority to, and the benefits of, U.S. Provisional Patent Application No. 62/662,512, filed on Apr. 25, 2018, the entire disclosure of which is hereby incorporated by reference.

### FIELD OF THE INVENTION

The field of the invention relates, generally, to data structures and, more particularly, to approaches that expedite the design process of data structures.

### BACKGROUND

Data structures are at the core of any data-driven software, from relational database systems, NoSQL key-value stores, operating systems, compilers, HCI systems, and scientific data management to any ad-hoc program that deals with increasingly growing data. Operations in the data-driven system/program go through a data structure when it accesses data. Efforts to redesign the system or to add new functionality typically require reassessing how data is to be stored and accessed. Thus, the design of data structures has been an active area of research since the onset of computer science and there is an ever-growing need for alternative designs, in particular due to the continuous advent of new applications that require tailored storage and access patterns in both industry and science as well as new hardware that requires specific storage and access patterns to ensure longevity and maximum utilization.

A data structure design includes a data layout that describes how data is stored, and algorithms that describe how basic functionalities (search, insert, etc.) are achieved over the specific data layout. A data structure can be as simple as an array or can be arbitrarily complex using sophisticated combinations of hashing, range and radix partitioning, careful data placement, compression and/or encodings. The data layout design itself may be further broken down into the base data layout and the indexing information that helps navigate the data. As used herein, the term “data structure design” refers to the overall design of the data layout, indexing, and the algorithms together as a whole. In addition, the term “design” refers to decisions that characterize the layout and algorithms of a data structure, such as, “Should data nodes be sorted?”, “Should they use pointers?”, and “How should we scan them exactly?”. The number of possible valid data structure designs explodes to >>10³⁶ even if the overall design is limited to only two different kinds of nodes. In full polymorphism—i.e., if every node may include different design decisions (e.g., given its data and access patterns)—the number of possible data structure designs grows to >>10¹⁰⁰. Accordingly, the design of data structure designs is generally a manual and slow process and relies heavily on the expertise and intuition of researchers and engineers. They are expected to mentally navigate the vast design space of data structures to make design choices and adapt to new hardware and workloads.

In addition, designing the data structure to optimize performance of a specific system and/or application may involve complexity. For example, when considering the data structure for a specific workload, the expert may have to decide whether to strip down an existing complex data structure, build off a simpler one, or design and build a new one from scratch. In a situation where the workload may shift (e.g., due to new application features), the expert has to evaluate how the performance will change and if redesign of the core data structures is necessary. If flash drives with more bandwidth or more system memory are added, the expert may have to decide whether to change the layout of the B-tree nodes or the size ratio in the LSM-tree. To improve throughput, the expert may have to decide how beneficial it would be to buy faster disks or more memory or to invest the same budget in redesigning and re-implementing a specific part of the core data structure.

This complexity typically leads to a slow design process and has severe cost side-effects. Because time to market is often of extreme importance, new data structure design, which is inherently an iterative process, effectively stops when a design “is due” and only rarely when it “is ready.” Generally, design efforts in industry are reactive (e.g., to new workload or hardware). Thus, the process of design extends beyond the initial design phase to periods of reconsidering the design given bugs or changes in the scenarios it supports. Further, the complexity makes it difficult to predict the impact of design choices, workloads, and hardware on performance.

Accordingly, there is a need for an approach that expedites the design process of data structures with limited involvement for the experts.

### SUMMARY

Embodiments of the present invention provide apparatus and methods for mapping the design space of data structures based at least in part on multiple data layout primitives; each data layout primitive corresponds to the smallest, fundamental layout aspect of the data structure. Thus, by selectively combining various data layout primitives, a data structure may be formed. In addition, embodiments of the invention may include multiple data access primitives, each corresponding to an operation in a workload for accessing the data stored in the data structure. In one embodiment, the data access primitives are classified into two levels—Level 1 primitives include or consist essentially of conceptual access patterns and Level 2 primitives include or consist essentially of actual implementations that signify specific sets of design choices. For example, a Level 1 primitive may include “Sorted Search,” and a Level 2 primitive may include binary search and interpolation search.

In various embodiments, one or more models are implemented to describe the cost (or latency) behavior for each Level 2 primitive. The model(s) may be trained and fitted for combinations of data and hardware profiles by running benchmarks that represent the behavior of the Level 2 primitives and learn a set of coefficients capturing the performance details of different hardware settings. As a result, embodiments of the invention may then accurately compute costs on arbitrary access method designs by synthesizing the costs associated with the data access primitive contained therein that is estimated using the model(s); this thereby obviates the need for going over the data or access to the specific machine.

Accordingly, in one aspect, the invention pertains to an apparatus for determining an operation cost of a computational workload. In various embodiments, the apparatus includes a computer memory for storing data in a data structure; and a computer processor configured to decompose the data structure into multiple data layout primitives, each data layout primitive corresponding to a smallest, fundamental layout aspect of the data structure; decompose the computational workload into multiple data access primitives, each data access primitive corresponding to a computational mechanism for accessing the data stored in the data structure; determine a hardware profile associated with the apparatus; and compute the operation cost of the computational workload on the apparatus based at least in part on the data layout primitives, the data access primitives, and the hardware profile.

The apparatus may further include an interface for receiving an input updating one or more data layout primitives, computational workload and/or hardware profile; the computer processor may then be further configured to update the operation cost based on the input. In addition, the computer processor may be further configured to classify the data layout primitives into multiple classes including one or more of node organization, node filters, partitioning, node physical placement and/or node metadata management. In some embodiments, the computer processor is further configured to classify the data access primitives into two levels including (i) the first level corresponding an abstract syntax tree having an access pattern and (ii) the second level corresponding to implementations for accessing the data in the data structure. For example, the first level may include a scan primitive, a sorted search primitive, a hash probe primitive, a Bloom filter probe primitive, a sort primitive, a random memory access primitive, a batched random memory access primitive, a unordered batch write primitive, an ordered batch write primitive and a scattered batch write primitive. In one embodiment, the computer processor is further configured to synthesize at least some of the first-level data access primitives, translate the synthesized data access primitives to corresponding second-level data access primitives and compute the operation cost based on the corresponding second-level data access primitives.

Additionally, the computer processor may be further configured to computationally train one or more cost models associated with each data access primitive based on the hardware profile and/or data properties. The computer processor may be further configured to synthesize the costs associated with the data access primitives based at least in part on the model(s). The cost model(s) may be parametric model(s).

In another aspect, the invention relates to an apparatus for determining an optimized data structure in a computer memory for storing data. In various embodiments, the apparatus includes a memory for storing multiple data layout primitives, each data layout primitive corresponding to a smallest, fundamental layout aspect of the data structure; and a computer processor configured to decompose a computational workload into multiple data access primitives, each data access primitive corresponding to a computational mechanism for accessing the data; determine a hardware profile associated with the apparatus; based at least in part on the data access primitives and the hardware profile, computationally identify a subset of the data layout primitives; and combine at least some of the identified data layout primitives of the subset into the optimized data structure. In one implementation, execution of the computational workload on the apparatus to access the data stored in the optimized data structure has a lowest computational cost among all possible combinations of the data layout primitives into data structures.

The apparatus may further include an interface for receiving an input updating one or more data access primitives and/or hardware profile; the computer processor may be then further configured to computationally update (i) the subset of the data layout primitives based on the input and (ii) the optimized data structure based on the updated subset of the data layout primitives. In one embodiment, the data layout primitives are classified into multiple classes including one or more of node organization, node filters, partitioning, node physical placement and/or node metadata management. In addition, the computer processor may be further configured to classify the data access primitives into two levels including (i) the first level corresponding an abstract syntax tree having an access pattern and (ii) the second level corresponding to implementations for accessing data in the memory. For example, the first level may include a scan primitive, a sorted search primitive, a hash probe primitive, a Bloom filter probe primitive, a sort primitive, a random memory access primitive, a batched random memory access primitive, a unordered batch write primitive, an ordered batch write primitive and a scattered batch write primitive. In one embodiment, the computer processor is further configured to synthesize at least some of the first-level data access primitives, translate the synthesized data access primitives to corresponding second-level data access primitives and compute the operation cost based on the corresponding second-level data access primitives.

In addition, the computer processor may be further configured to computationally train one or more cost models associated with each data access primitive based on the hardware profile and/or data properties. In one embodiment, the computer processor may be further configured to synthesize costs associated with the data access primitives based at least in part on the model(s). The cost model(s) may be parametric model(s).

Another aspect of the invention relates to an apparatus for reducing an operation cost associated with a computational workload. In various embodiments, the apparatus includes a memory for storing (i) multiple data layout primitives, each data layout primitive corresponding to a smallest, fundamental layout aspect of the data structure and (ii) data in a data structure; and a computer processor configured to decompose the data structure into a subset of the data layout primitives; decompose the computational workload into multiple data access primitives, each data access primitive corresponding to an approach for accessing the data; determine a hardware profile associated with multiple hardware components of the apparatus for storing and accessing the data stored in the data structure; computationally predict a computational cost associated with execution of the computational workload on the apparatus to access the data stored in the data structure by using a cost predictor that has been computationally trained to predict computational costs associated with executing each of the data access primitives on subsets of the hardware components to access subsets of the data layout primitives; and based at least in part on the predicted computational cost and the trained cost predictor, adjust the subset of the data layout primitives, the data access primitives and/or one of the hardware components for reducing the computational cost of the computational workload.

In one embodiment, the data layout primitives are classified into multiple classes including one or more of node organization, node filters, partitioning, node physical placement or node metadata management. In addition, the computer processor may be further configured to classify the data access primitives into two levels including (i) the first level corresponding an abstract syntax tree having an access pattern and (ii) the second level corresponding to implementations for accessing the data in the data structure. For example, the first level may include a scan primitive, a sorted search primitive, a hash probe primitive, a Bloom filter probe primitive, a sort primitive, a random memory access primitive, a batched random memory access primitive, a unordered batch write primitive, an ordered batch write primitive and a scattered batch write primitive. In some embodiments, the computer processor is further configured to synthesize at least some of the first-level data access primitives, translate the synthesized data access primitives to corresponding second-level data access primitives and compute the operation cost based on the corresponding second-level data access primitives.

In yet another aspect, the invention pertains to a method of determining an operation cost of a computational workload; the computation workload is executed on a computational apparatus and accessing data stored in a data structure therein. In various embodiments, the method includes decomposing the data structure into multiple data layout primitives, each data layout primitive corresponding to a smallest, fundamental layout aspect of the data structure; decomposing the computational workload into multiple data access primitives, each data access primitive corresponding to a computational mechanism for accessing the data stored in the data structure; determining a hardware profile associated with the apparatus; and computing the operation cost of the computational workload on the apparatus based at least in part on the data layout primitives, the data access primitives, and the hardware profile.

The method may further include receiving an input updating one or more data layout primitives, computational workload and/or hardware profile; and updating the operation cost based on the input. In addition, the method may further include classifying the data layout primitives into multiple classes including one or more of node organization, node filters, partitioning, node physical placement or node metadata management. In some embodiments, the method further includes classifying the data access primitives into two levels including (i) the first level corresponding an abstract syntax tree having an access pattern and (ii) the second level corresponding to implementations for accessing the data in the data structure. For example, the first level may include a scan primitive, a sorted search primitive, a hash probe primitive, a Bloom filter probe primitive, a sort primitive, a random memory access primitive, a batched random memory access primitive, a unordered batch write primitive, an ordered batch write primitive and a scattered batch write primitive. In one embodiment, the method further includes synthesizing at least some of the first-level data access primitives, translating the synthesized data access primitives to corresponding second-level data access primitives and computing the operation cost based on the corresponding second-level data access primitives.

Additionally, the method may further include computationally training one or more cost models associated with each data access primitive based on the hardware profile and/or data properties. In one embodiment, the method further includes synthesizing costs associated with the data access primitives based at least in part on the model(s). The cost model(s) may be parametric model(s).

Still another aspect of the invention relates to a method of determining an optimized data structure in a computer memory for storing data. In various embodiments, the method includes storing multiple data layout primitives, each data layout primitive corresponding to a smallest, fundamental layout aspect of the data structure; decomposing a computational workload into multiple data access primitives, each data access primitive corresponding to a computational mechanism for accessing the data; determining a hardware profile associated with the apparatus; based at least in part on the data access primitives and the hardware profile, computationally identifying a subset of the data layout primitives; and combining at least some of the identified data layout primitives of the subset into the optimized data structure. In one implementation, execution of the computational workload on the apparatus to access the data stored in the optimized data structure has a lowest computational cost among all possible combinations of the data layout primitives into data structures. In one embodiment, the method further includes receiving an input updating one or more data access primitives and/or hardware profile; and based on the input, computationally updating (i) the subset of the data layout primitives and (ii) the optimized data structure. In one embodiment, the data layout primitives are classified into multiple classes including one or more of node organization, node filters, partitioning, node physical placement and/or node metadata management. In addition, the method may further including classifying the data access primitives into two levels comprising (i) the first level corresponding an abstract syntax tree having an access pattern and (ii) the second level corresponding to implementations for accessing data in the memory. For example, the first level may include a scan primitive, a sorted search primitive, a hash probe primitive, a Bloom filter probe primitive, a sort primitive, a random memory access primitive, a batched random memory access primitive, a unordered batch write primitive, an ordered batch write primitive and a scattered batch write primitive. In one embodiment, the method further includes synthesizing at least some of the first-level data access primitives, translating the synthesized data access primitives to corresponding second-level data access primitives and computing the operation cost based on the corresponding second-level data access primitives.

In addition, the method may further include computationally training one or more cost models associated with each data access primitive based on the hardware profile and/or data properties. In one embodiment, the method further includes synthesizing costs associated with the data access primitives based at least in part on the model(s). The cost model(s) may be parametric model(s).

In another aspect, the invention relates to a method for reducing an operation cost associated with a computational workload. In various embodiments, the method includes storing (i) multiple data layout primitives, each data layout primitive corresponding to a smallest, fundamental layout aspect of the data structure and (ii) data in a data structure; decomposing the data structure into a subset of the data layout primitives; decomposing the computational workload into multiple data access primitives, each data access primitive corresponding to an approach for accessing the data; determining a hardware profile associated with multiple hardware components of the apparatus for storing and accessing the data stored in the data structure; computationally predicting a computational cost associated with execution of the computational workload on the apparatus to access the data stored in the data structure by using a cost predictor that has been computationally trained to predict computational costs associated with executing each of the data access primitives on subsets of the hardware components to access subsets of the data layout primitives; and based at least in part on the predicted computational cost and the trained cost predictor, adjusting the subset of the data layout primitives, the data access primitives and/or one of the hardware components for reducing the computational cost of the computational workload.

In one embodiment, the data layout primitives are classified into multiple classes including one or more of node organization, node filters, partitioning, node physical placement or node metadata management. In addition, the method may further include classifying the data access primitives into two levels including (i) the first level corresponding an abstract syntax tree having an access pattern and (ii) the second level corresponding to implementations for accessing the data in the data structure. For example, the first level may include a scan primitive, a sorted search primitive, a hash probe primitive, a Bloom filter probe primitive, a sort primitive, a random memory access primitive, a batched random memory access primitive, a unordered batch write primitive, an ordered batch write primitive and a scattered batch write primitive. In some embodiments, the method further includes synthesizing at least some of the first-level data access primitives, translating the synthesized data access primitives to corresponding second-level data access primitives and computing the operation cost based on the corresponding second-level data access primitives.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 depicts an architecture of an exemplary approach for performing the data structure design and cost synthesis in accordance with various embodiments;

FIG. 2A depicts a list of exemplary data layout primitives and synthesis examples of data structures in accordance with various embodiments;

FIGS. 2B and 2C depict exemplary data layout primitives and examples of synthesizing mode layouts of various data structures in accordance with various embodiments;

FIG. 2D is a flow chart of an exemplary approach for applying a library of data layout design primitives to describe a data structure in accordance with various embodiments;

FIG. 3 depicts an exemplary list of access primitives in accordance with various embodiments;

FIG. 4 depicts an exemplary approach for training and fitting one or more models for a data access primitive in accordance with various embodiments;

FIG. 5 is a flow chart depicting an exemplary approach for synthesizing an operation cost for an operation in a workload in a data structure specification in accordance with various embodiments;

FIG. 6 depicts flow charts for synthesizing the operation costs for a range query and a bulk-loading operation in accordance with various embodiments;

FIG. 7 depicts an exemplary algorithm for completing a partial data structure layout specification in accordance with various embodiments;

FIG. 8A is a flow chart depicting an exemplary approach for predicting an operation cost of a computational workload on a computational apparatus in accordance with various embodiments;

FIG. 8B is a flow chart depicting an exemplary approach for training or constructing one or more cost models for a data access primitive in accordance with various embodiments;

FIG. 8C is a flow chart depicting an exemplary approach for determining an optimized data structure in a computer memory for storing data in accordance with various embodiments;

FIG. 8D is a flow chart depicting an exemplary approach for reducing the operation cost associated with a computational workload in accordance with various embodiments;

FIG. 9 depicts computed latencies (or operation costs) of various dictionary operations in various data structure designs across a set of hardware in accordance with various embodiments;

FIG. 10A illustrates computational and experimental results of the latency (or operation cost) for a bulk-loading operation in various data structures in accordance with various embodiments;

FIG. 10B depicts the training time for training the data access primitives on various machines in accordance with various embodiments;

FIG. 11A illustrates computational and experimental results of the latency (or operation cost) on various machines in accordance with various embodiments;

FIG. 11B illustrates an improved performance resulting from the workload skew in accordance with various embodiments;

FIGS. 12A and 12B depict exemplary specifications of the data structures in accordance with various embodiments; and

FIG. 13 is a block diagram illustrating a facility for determining an operation cost of a computational workload that accesses data stored in a data structure in a computational apparatus in accordance with various embodiments.

### DETAILED DESCRIPTION

Embodiments of the present invention relate to approaches for accelerating the process of data structure designs by providing guidance about the possible design space and allowing quick testing of how a given design fits a workload and hardware setting as further described below. Various embodiments as further described below can synthesize complex operations from their fundamental components and then develop a hybrid way (e.g., through both benchmarks and models but without significant human effort needed) to assign costs to each component individually. Because a small set of cost models may be learned for fine-grained data access patterns, based thereon, the cost of complex dictionary operations for arbitrary designs in the possible design space of data structures can then be synthesized.

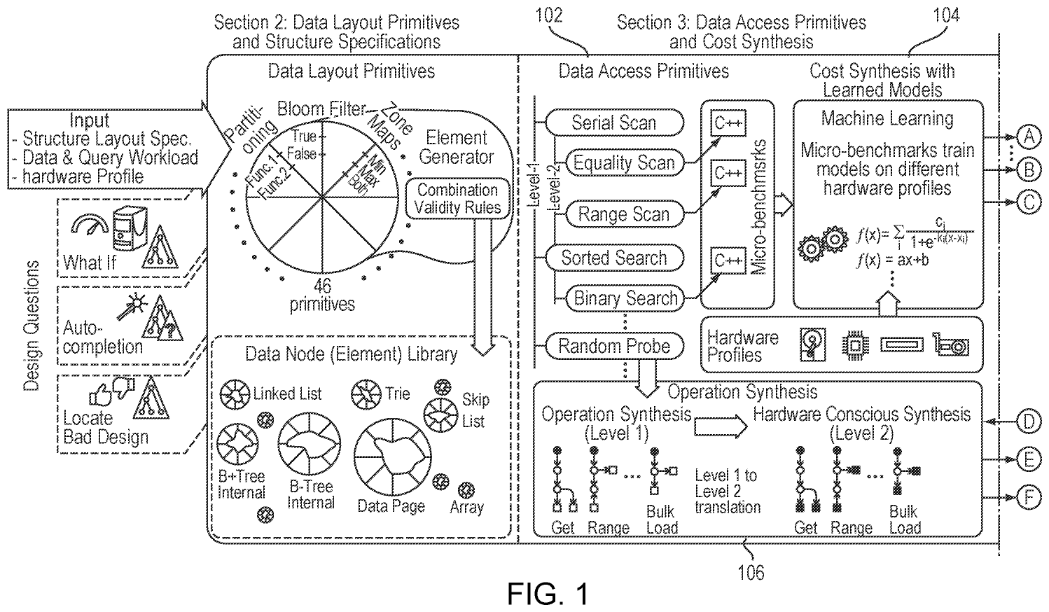

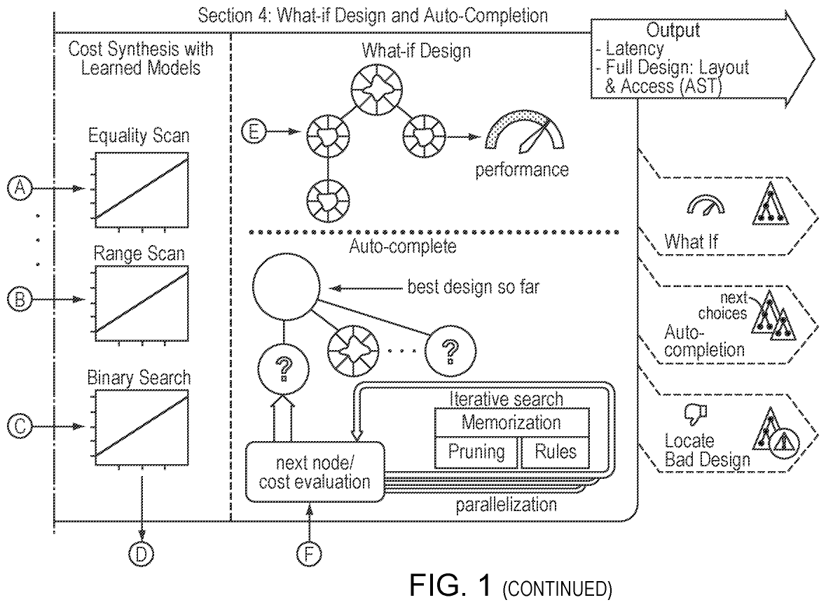

FIG. 1 depicts an exemplary architecture and components of an embodiment of the invention. The middle part of FIG. 1 depicts components for synthesizing the operation cost of a workload, including s set of data access primitives 102, the cost learning module 104 for training cost models for each access primitive, depending on hardware and data properties, and the operation and cost synthesis module 106 that synthesizes the operations and their costs from the access primitives 102 and the learned models.

Additionally, embodiments of the invention may use the operation and cost synthesis module 106 to interactively answer complex what-if design questions (such as the impact of changes to design, workload and hardware), adjust the conventional data structure design, workload and/or hardware component for reducing the cost, and determine an optimized data structure as further described below.

### A. Data Layout Primitives and Structure Specifications

1) Data Layout Primitives

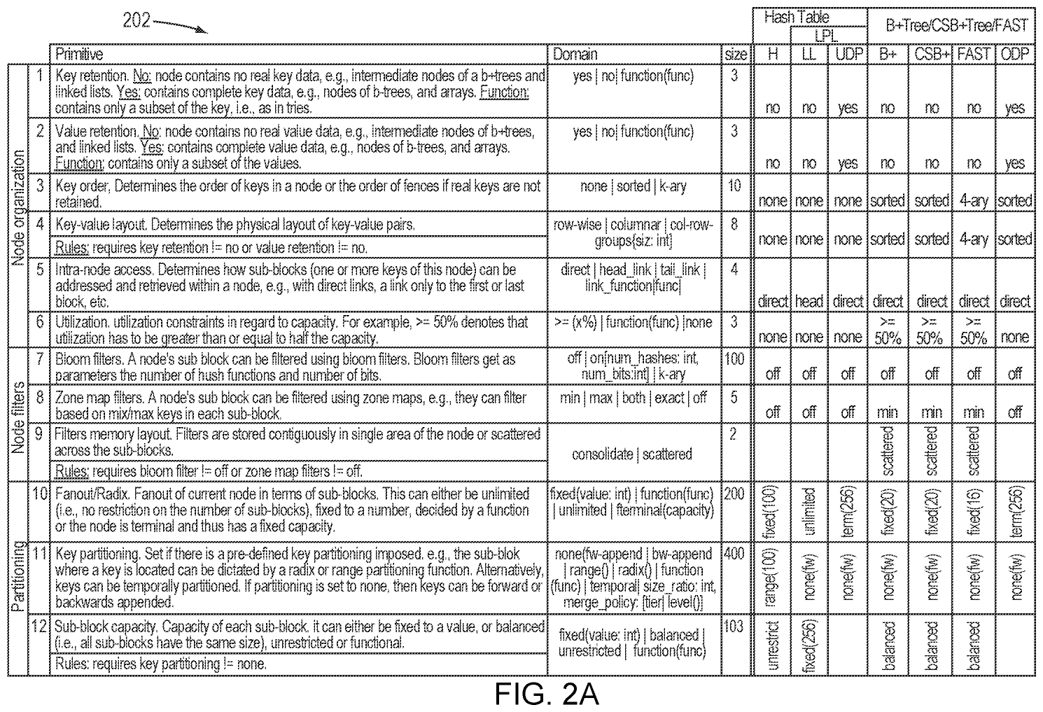

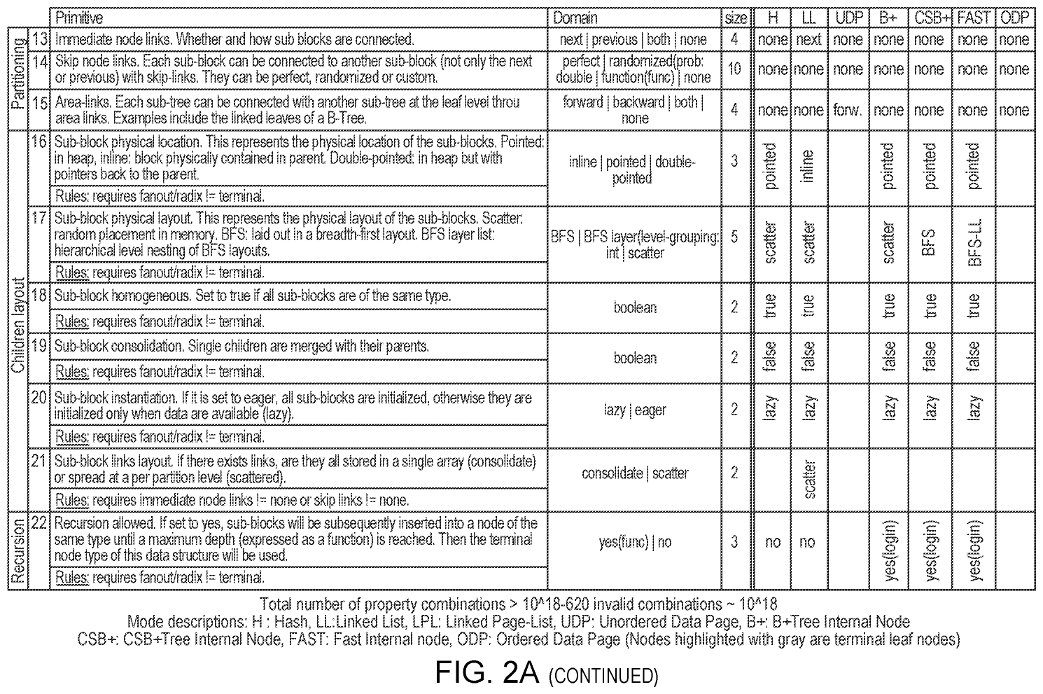

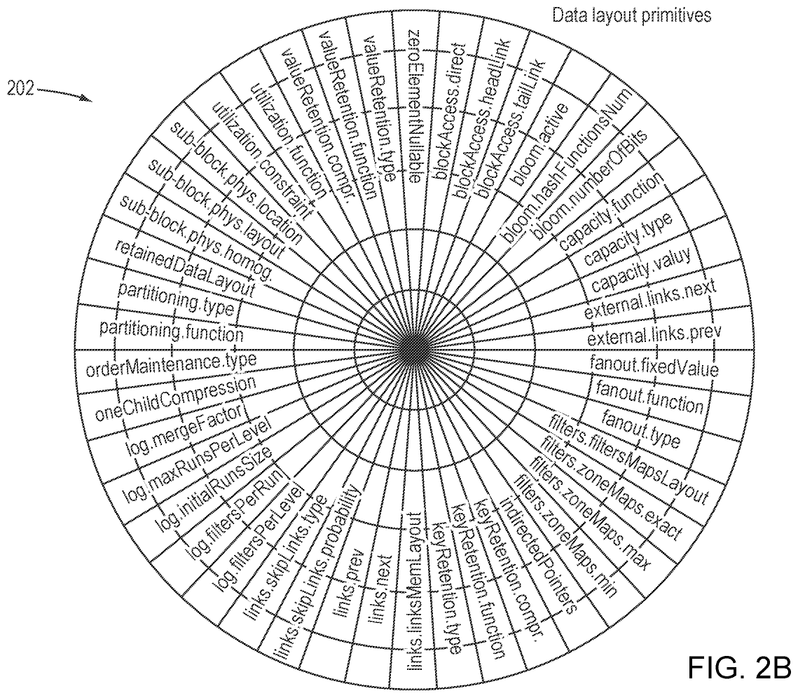

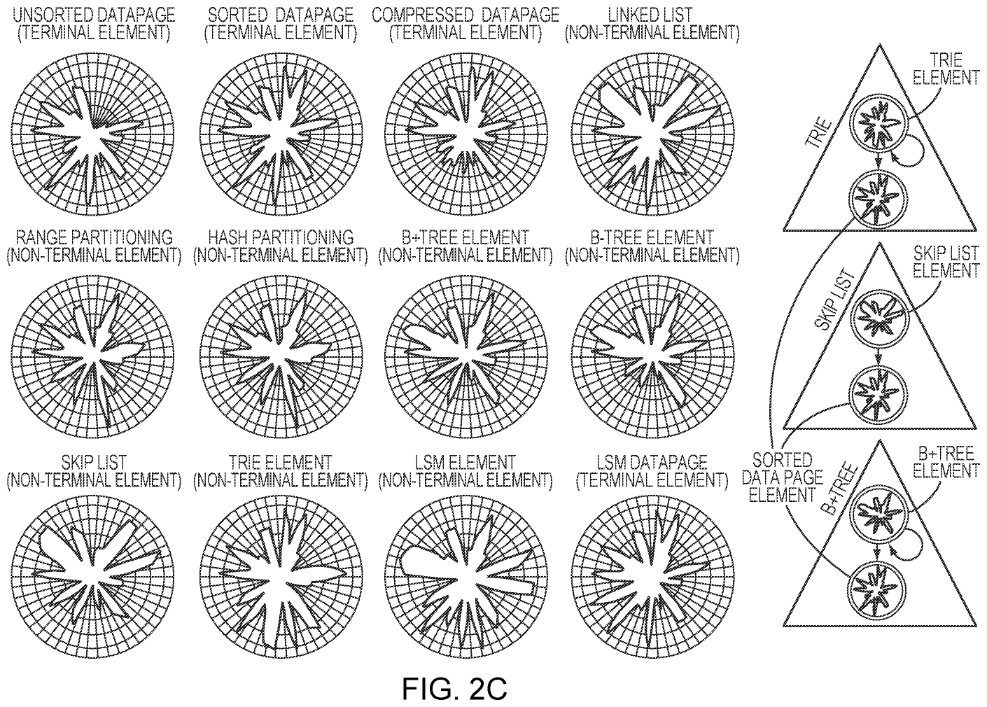

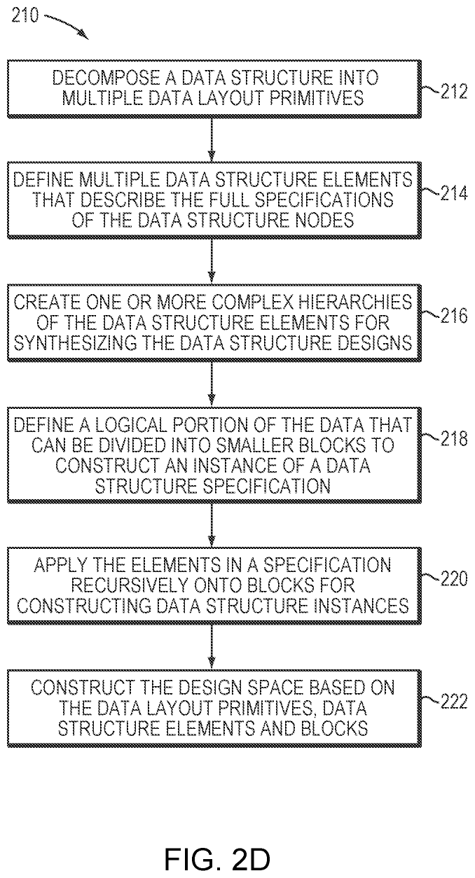

Referring to FIGS. 2A-2C, in various embodiments, a set of data layout primitives 202 is first created using, for example, a trial-and-error procedure. The layout primitives represent the smallest, fundamental design choices (i.e., cannot be broken down into more useful design choices) when constructing a data structure layout. The set of primitives can then map the known space of design concepts. Generally, each layout primitive belongs to a class of primitives, depending on the high-level design concept it refers to (such as, node data organization, partitioning, node physical placement, and node metadata management) and may or may not be combined with one another. Within each class, individual primitives define design choices and allow for alternative tunings. FIG. 2A depicts an exemplary set of primitives describing basic data layouts and cache conscious optimizations for reads. For example, “Key Order (none|sorted|k-ary|in-order)” defines how data is laid out in a node, and “Key Retention (nonelfullIfunc)” defines whether and how keys are included in a node. In this way, in a B+tree all nodes use “sorted” for order maintenance, while internal nodes use “none” for key retention as they only store fences and pointers, and leaf nodes use “full” for key retention.

2) Data Structure Elements

In addition, various embodiments of the invention define multiple elements for describing full specifications of the data structure nodes; each element defines the data and access methods for accessing a single node's data. An element may be “terminal” or “non-terminal”—i.e., an element may describe a node that further partitions data to more nodes or not. For example, a non-terminal element may include the “fanout” primitive whose value represents the maximum number of children that would be generated when a node partitions data, and a terminal element may include a value that represents the capacity of a terminal node. Typically, a data structure specification may include one or more elements—while at least one terminal element is necessary, zero or more non-terminal elements may be included. In some embodiments, each element has a destination element (except terminal ones) and a source element (except the root). Recursive connections are allowed to the same element.

FIG. 2B depicts a flat representation of the primitives identified in FIG. 2A that creates an entry for every primitive signature. Specifically, FIG. 2A provides complete specifications of Hash-table, Linked-list, B+tree, Cache-conscious B-tree, and fast architecture sensitive tree (FAST). The radius depicts the domain of each primitive but different primitives may have different domains, visually depicted via the multiple inner circles in the radar plots of FIG. 2B. FIG. 2C depicts descriptions of nodes of known data structures as combinations of the base primitives. Even visually it starts to become apparent that state-of-the-art designs which are meant to handle different scenarios are “synthesized from the same pool of design concepts.” For example, using the non-terminal B+tree element and the terminal sorted data page element, a full B+tree specification can be constructed. In addition, data is recursively broken down into internal nodes using the B+tree element until the leaf level is reached—i.e., when partitions reach the terminal node size. FIG. 2C also depicts Trie and Skip-list specifications.

3) Elements “Without Data”

For flat data structures without an indexing layer (e.g., linked-lists and skip-lists), there need to be elements in the specification that describe the algorithm used to navigate the terminal nodes. Given that this algorithm is effectively a model, it does not rely on any data, and so such elements do not translate to actual nodes; rather, they only affect algorithms that navigate across the terminal nodes. For example, a linked-list element in FIG. 2A may describe that data is divided into nodes that can only be accessed via following the links connecting terminal nodes. Similarly, embodiments of the invention can create complex hierarchies of non-terminal elements that do not store any data but instead synthesize a collective model of how the keys are to be distributed in the data structure, e.g., based on their values or other properties of the workload. These elements may lead to multiple hierarchies of both non-terminal nodes with data and terminal nodes, synthesizing data structure designs that treat parts of the data differently.

4) Recursive Design Through Blocks

Some embodiments of the invention further define a block as a logical portion of the data that can be divided into smaller blocks to construct an instance of a data structure specification. Thus, the elements in a specification are the “atoms” that can be applied recursively onto blocks for constructing data structure instances. Initially, there is a single block of data—i.e., all data. Once all elements have been applied, the original block may be broken down into a set of smaller blocks that correspond to the internal nodes (if any) and the terminal nodes of the data structure. Elements without data can be thought of as if they apply on a logical data block that represents part of the data with a set of specific properties (i.e., all data if this is the first element) and partitions the data with a particular logic into further logical blocks or physical nodes. This recursive construction is used when testing, evaluating costs, and searching through multiple possible designs concurrently over the same data for a given workload and hardware. In addition, the recursive construction is helpful to visualize designs as if “data is pushed through the design” based on the elements and logical blocks.

### 5) Cache-Conscious Designs

One critical aspect of data structure design is the relative positioning of its nodes, i.e., how “far” each node is positioned with respect to its predecessors and successors in a query path. This aspect is critical to the overall cost of traversing a data structure. In various embodiments, the design space may dictate how nodes are positioned explicitly: each non-terminal element defines how its children are positioned physically with respect to each other and with respect to the current node. For example, setting the layout primitive “Sub-block physical layout” to the breadth-first search (BFS) tells the current node that its children are laid out sequentially. In addition, setting the layout primitive “Sub-blocks homogeneous” to true implies that all its children have the same layout (and therefore fixed width), and allows a parent node to access any of its child nodes directly with a single pointer and reference number. This, in turn, makes it possible to fit more data in internal nodes because only one pointer is needed and thus more fences can be stored within the same storage budget. Such primitives allow not only specifying designs, such as Cache Conscious B+tree (FIG. 2A provides the complete specification), but also the possibility of generalizing the optimizations made therein to arbitrary structures.

Similarly, FAST can be described by embodiments of the invention. For example, the primitive, “Sub-block physical location,” may be first set to inline, specifying that the children nodes are directly after the parent node physically. Second, the children nodes can be set homogeneously, and finally, the children are set to have a sub-block layout of “BFS Layer List (Page Size/Cache Line Size, 1).” Here, the BFS layer list specifies that on a higher level, a BFS layout of sub-trees containing Page Size/Cache Line Size layers may be necessary; however, inside of those sub-trees pages are laid out in BFS manner by a single level. The combination matches the combined Page Level blocking and Cache Line level blocking of FAST. Additionally, embodiments of the invention realize that all child node physical locations may be calculated via offsets, thereby eliminating all pointers. Again, FIG. 2A provides the complete specification.

### 6) Size of the Design Space

The data layout primitives, data structure elements and blocks described above can be represented as follows for constructing the design space: a primitive pᵢ belongs to a domain of values Pᵢ and describes a layout aspect of a data structure node; and a data structure element E is defined as a set of data layout primitives: E={p₁, . . . , pₙ}∈Pᵢ× . . . ×Pₙ, that uniquely identify it. Given a set of Inv(P) invalid combinations, the set of all possible elements [symbol] , (i.e., node layouts) that can be designed as distinct combinations of data layout primitives has the following cardinality:

| [symbol] |=Pᵢ× . . . ×Pₙ−Inv(P)=Π_{∀P}_{ᵢ}_{∈E}|Pᵢ|−Inv(P) (1)

Each non-terminal element E ∈ [symbol] , applied on a set of data entries D ∈ [symbol] , uses function B_{E}(D)={D₁, . . . , D_{f}} to divide D into f blocks such that D₁∪ . . . ∪D_{f}=D. A polymorphic design where every block may then be described by a different element leads to the following recursive formula for the cardinality of all possible designs.

c_{poly}(D)=| [symbol] |+Π_{∀E∈} [symbol] Π_{∀D}_{ᵢ}_{∈B}_{_{E}}_{(D)}c_{poly} (2)

In addition, assume the same fanout f across all nodes and terminal node size equal to page size p_{size}, then

$$N = ⌈ \frac{\vert D \vert}{{p}_{s t z e}} ⌉$$

is the total number of pages in which the data can be divided, and h=┌log_{f}(N)┐ is the height of the hierarchy. The result of Eq. (2) can then be approximated by considering that there is |E| possibilities for the root element and f×|E| possibilities for its resulting partitions which in turn have f×|E| possibilities each up to the maximum level of recursion h=┌log_{f}(N)┌. This leads to the following result:

c_{poly}(D)≈| [symbol] |×(f×| [symbol] |)^{┌log}^{_{f}}^{(N)┐} (3)

The data structure designs may use only two distinct elements, each one describing all nodes across groups of levels of the structure. For example, B-tree designs use one element for all internal nodes and one for all leaves. This gives the following design space for most standard designs.

cₛₜₐₙ(D)≈| [symbol] |² (4)

Using Eqs (1), (3) and (4), the possible design space for different kinds of data structure designs may be estimated. For example, given the existing library of data layout primitives, and by limiting the domain of each primitive as shown in FIG. 2A, |E| is estimated to be 10¹⁸ using Eq. (1); this indicates that data structure layouts can be described from a design space of 10¹⁸ possible node elements and the combinations thereof. This number includes only valid combinations of layout primitives—i.e., all invalid combinations as defined by the rules in FIG. 2A are excluded. Thus, there is a design space of 10³⁶ for standard two-element structures (e.g., where B-tree and Trie belong) and 10⁵⁴ for three-element structures (e.g., where MassTree and Bounded-Disorder belong). For polymorphic structures, the number of possible designs grows more quickly, and it also depends on the size of the training data used to find a specification, e.g., it is >10¹⁰⁰ for 10¹⁵ keys.

FIG. 2D is a flow chart depicting an exemplary approach 210 for applying the library of data layout design primitives 202 to describe a data structure in accordance with various embodiments. In a first step 212, a data structure is decomposed into multiple data layout primitives 202; the data layout primitives corresponding to known data structures may form a library of data layout primitives to map the known space of design concepts. The data layout primitives generally represent the smallest, fundamental design choices when constructing a data structure layout and can be created using a trial-and-error procedure. In a second step 214, multiple data structure elements that describe the full specifications of the data structure nodes may be defined; each element may be terminal or non-terminal and typically defines the data and access methods for accessing a single node's data. In a third step 216, one or more complex hierarchies of non-terminal and/or terminal elements may be created for synthesizing the data structure designs. In a fourth step 218, a logical portion of the data that can be divided into smaller blocks to construct an instance of a data structure specification is defined. The elements in a specification can then be applied recursively onto blocks for constructing data structure instances (in a fifth step 220 ). In a sixth step 222, the data layout primitives, data structure elements and blocks described above may then be utilized to construct the design space. The design space may then dictate how the nodes are positioned in the data structure. For example, each non-terminal element may define how its children are positioned physically with respect to each other and with respect to the current node.

The numbers in the above example illustrate that data structure design is still a wide-open space with numerous opportunities for innovative designs as data keeps growing, application workloads keep changing, and hardware keeps evolving. Even with hundreds of new data structures manually designed and published each year, this is a slow pace to test all possible designs and to be able to argue about how the numerous designs compare. Embodiments described herein advantageously accelerates this process by providing guidance about what is the possible design space and allowing to quickly test how a given design fits a workload and hardware setting as further described below.

### B. Data Access Primitives and Cost Synthesis

Traditional cost analysis in systems and data structures is performed through experiments and the development of analytical cost models. These approaches require significant expertise and time and are sensitive to hardware and workload properties. Thus, they are not scalable particularly when multiple different parts of the massive design space are tested. Various embodiments described herein can synthesize complex operations from their fundamental components and then develop a hybrid way (e.g., through both benchmarks and models but without significant human effort needed) to assign costs to each component individually. The main idea is that a small set of cost models may be learned for fine-grained data access patterns; based thereon, the cost of complex dictionary operations for arbitrary designs in the possible design space of data structures can then be synthesized.

1) Cost Synthesis from Data Access Primitives

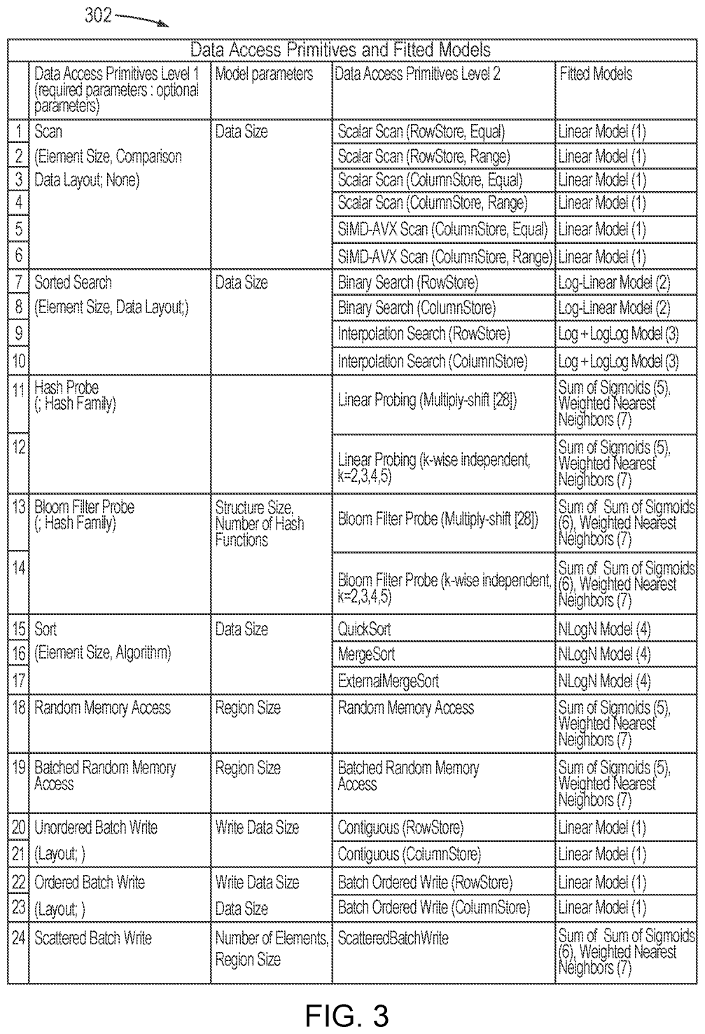

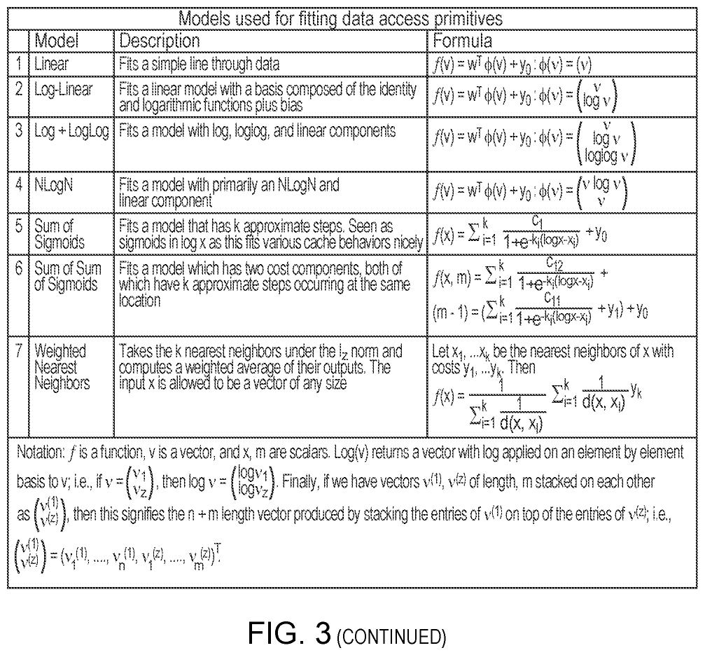

In various embodiments, a computational workload is decomposed into multiple data access primitives; each access primitive characterizes one aspect of how data is accessed. FIG. 3 depicts a list of exemplary data access primitives 302 in accordance herewith. For example, the access primitive 302 may be a binary search, a scan, a random read, a sequential read or a random write. The goal is that these primitives are fundamental enough so that they can synthesize operations over arbitrary designs as sequences of such primitives. In one implementation, a “data calculator” in accordance with the invention includes two levels of access primitives; Level 2 access primitives are nested under Level 1 primitives. For example, a scan is a Level 1 access primitive used any time an operation needs to search a block of data where there is no order. At the same time, a scan may be designed and implemented in more than one way; this may be represented by Level 2 access primitives. For example, a scan may use SIMD instructions for parallelization if keys are nicely packed in vectors, and predication to minimize branch mispredictions with certain selectivity ranges. In the same way, a sorted search may use interpolation search if keys are arranged with uniform distribution. In this way, each Level 1 primitive is a conceptual access pattern, while each Level 2 primitive is an actual implementation that signifies a specific set of design choices. Every Level 1 access primitive has at least one Level 2 primitive and may be extended with any number of additional ones.

2) Learned Cost Models

In addition, one or more models may be included to describe the performance behavior (e.g., latency or operation cost) for each Level 2 primitive. In one embodiment, the models are not static; rather, they are trained and fitted for combinations of data and hardware profiles as both those factors drastically affect the performance. To train a model, each Level 2 primitive may include a minimal implementation that captures the behavior of the primitive, i.e., it isolates the performance effects of performing the specific action. For example, an implementation for a scan primitive simply scans an array, while an implementation for a random access primitive simply tries to access random locations in memory. These implementations are used to run a sequence of benchmarks to collect data for learning a model for the behavior of each primitive. Implementations may be in the target language/environment.

In various embodiments, the models are simple parametric models. For example, a linear model may be applied for scans, a logarithmic model may be applied for binary searches, and a step-function model (based on the probability of caching) may be applied for smoothing out random memory accesses. These simple models may have many advantages: they are interpretable, they train quickly, and they do not need a lot of data to converge. Through the training process, coefficients of those models may be learned to capture hardware properties such as CPU and data movement costs.

Typically, hardware and data profiles hold descriptive information about hardware and data, respectively (e.g., data distribution for data, and CPU, bandwidth, etc. for hardware). Thus, when an access primitive is trained on a data profile, it runs on a sample of such data, and when it is trained for a hardware profile, it runs on this exact hardware. Afterward, various design questions may be utilized to obtain accurate cost estimations on arbitrary access method designs without going over the data or having to have access to the specific machine. Overall, this is an offline process that is done once and may be repeated to include new hardware and data profiles and/or to include new access primitives.

3) Binary Search Model

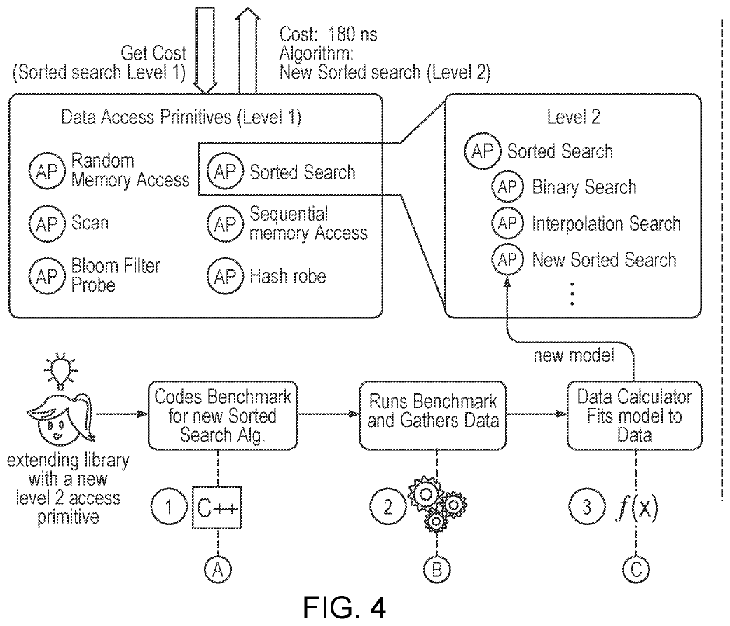

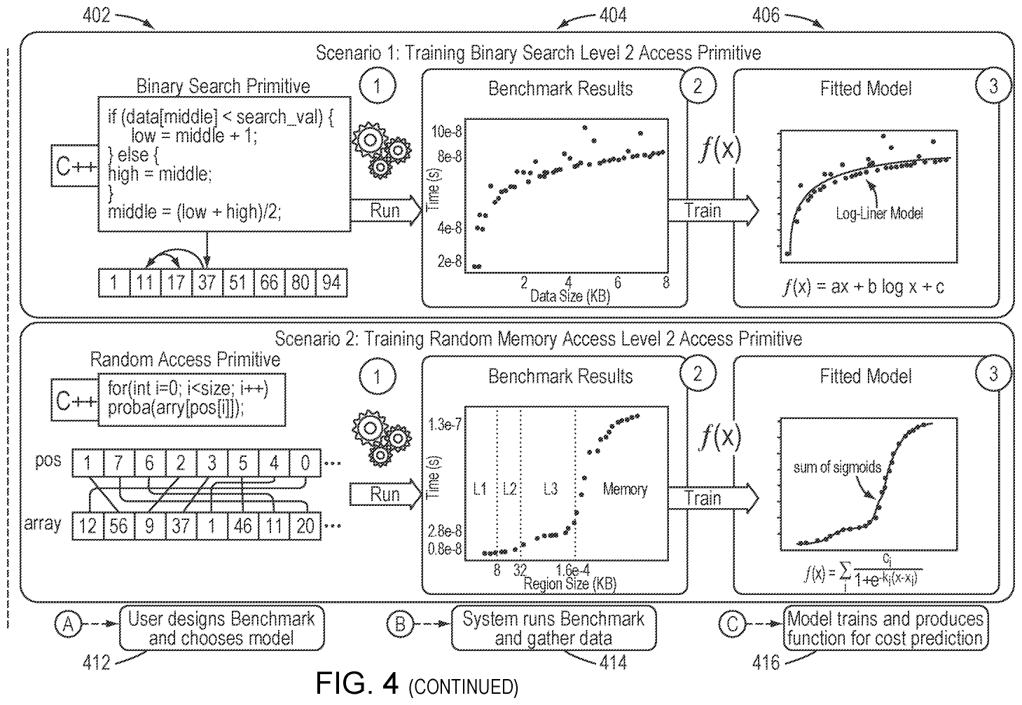

FIG. 4 illustrate exemplary approaches for constructing the models for a Level 2 primitive of binary searching a sorted array. As shown in step 402, the primitive contains a code snippet that implements the bare minimum behavior. The benchmark results of running the primitive indicate that performance is related to the size of the array by a logarithmic component (as shown in step 404). In addition, there is a bias as the relationship for small array sizes (e.g., having 4 or 8 elements) may not fit exactly a logarithmic function. In some embodiments, a linear term is introduced to capture some small linear dependency on the data size. Thus, the cost of binary searching an array of n elements can be approximated as f(n)=c₁n+c₂ log n+y₀ where c₁, c₂, and y₀ are coefficients learned through linear regression. The values of these coefficients help translate the abstract model, f(n)=O(log n), into a realized predictive model which has taken into account factors, such as CPU speed and the cost of memory accesses across the sorted array for the specific hardware. The resulting fitted model is then created in step 406. This learned model may then be utilized to query for the performance of a binary search within the trained range of data sizes. For example, the learned model may be used when querying a large sorted array as well as a small node of a complex data structure that is sorted.

In various embodiments, certain critical aspects of the training process described above are automated. For example, the data range for training a primitive may depend on the memory hierarchy (e.g., size of caches, memory, etc.) on the target machine and/or the target setting in the application (i.e., memory only, or also disk/flash, etc.). As a result, these parameters affect the length of the training process. Thus, in various embodiments, the memory hierarchy and/or the target setting in the application are handled through high-level knobs, letting the lower level tuning choices be determined using the systems and approaches described herein. In addition, identification of convergence may be automated. There exist primitives that require more training than others (e.g., due to more complex code, random access or sensitivity to outliers), and so the number of benchmarks and data points collected may not be a fixed decision.

4) Synthesizing Latency Costs

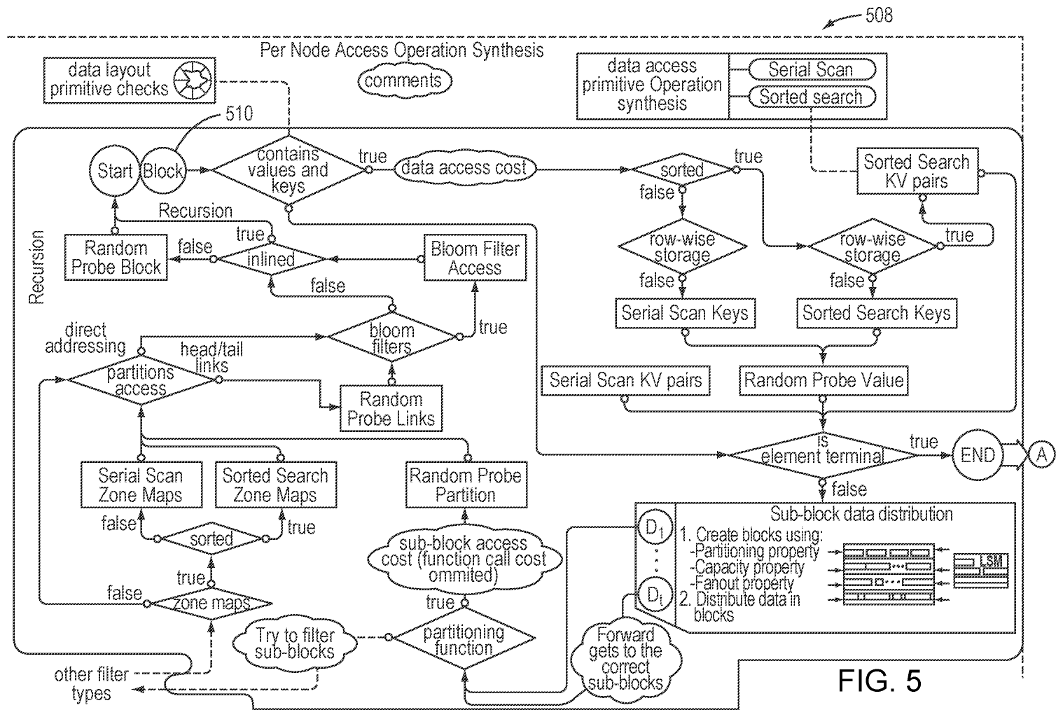

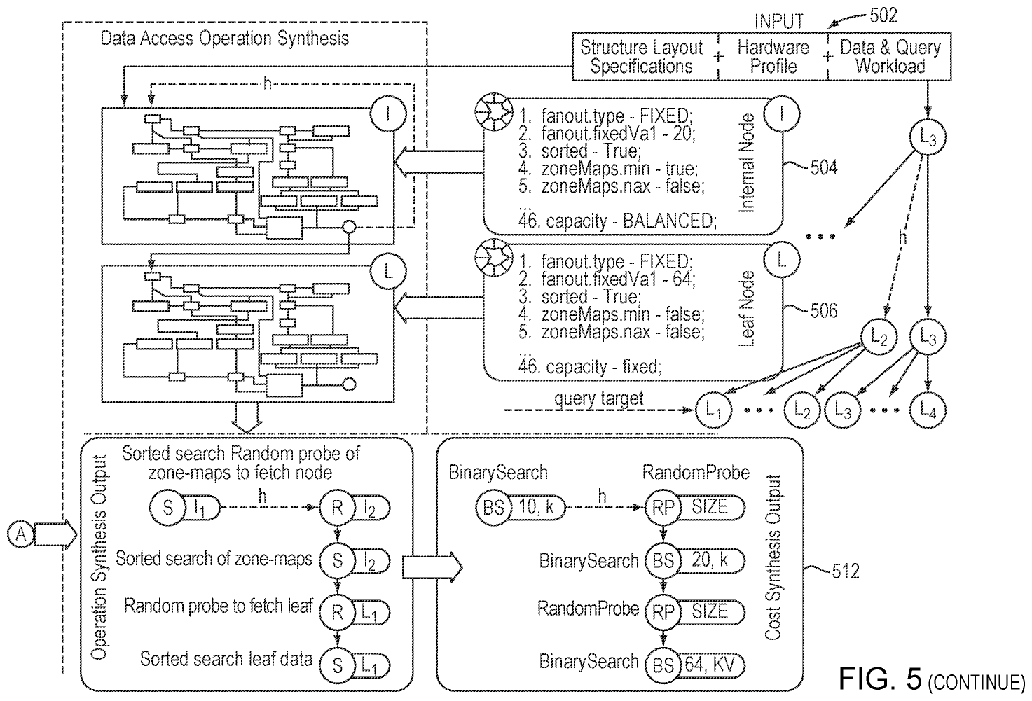

In various embodiments, given a data layout specification and a workload, Level 1 access primitives are used to synthesize operations and subsequently each Level 1 primitive is translated to the appropriate Level 2 primitive to compute the cost of the overall operation. FIG. 5 depicts this process and an example specifically for the “Get” operation. This is an expert system, i.e., a sequence of rules that based on a given data structure specification define how to traverse its nodes. As depicted at the top right corner 502 of FIG. 5, the input is a data structure specification, a test data set, and the operation that requires a cost, e.g., Get key x. The process simulates populating the data structure with the data to figure out how many nodes exist, the height of the structure, etc. This is because to accurately estimate the cost of an operation, the expected state of the data structure at the particular moment in the workload may be considered. This may be performed by recursively dividing the data into blocks given the elements used in the specification.

The structure in FIG. 5 includes two elements 504, 506, one for internal nodes and one for leaves. For every node, the operation synthesis process takes into account the data layout primitives used. For example, if a node is sorted, it uses binary search; but if the node is unsorted, it uses a full scan. The rhombuses on the left side 508 of FIG. 5 reflect the data layout primitives that operation “Get” relies on, while the rounded rectangles reflect data access primitives that may be used. For each node, the per-node operation synthesis procedure implemented in one embodiment (starting from the left top side 510 of FIG. 5) first checks whether this node is internal by checking whether the node contains keys or values. If the node is not internal, the synthesis procedure proceeds to determine which node it may visit next (left side of FIG. 5). If the node is internal, the synthesis procedure continues to process the data and values (right side of FIG. 5). A non-terminal element leads to data of this block being split into f new blocks and the process follows the relevant blocks only—i.e., the blocks that this operation needs to visit to resolve.

In addition, various embodiments of the present invention generate an abstract syntax tree with the access patterns of the path it had to go through; this may be expressed in terms of Level 1 access primitives (bottom right part 512 of FIG. 5) and subsequently be translated into to a more detailed abstract syntax tree, where all Level 1 access primitives are translated to Level 2 access primitives along with the estimated cost for each one, given the particular data size, hardware input, and any primitive specific input. The overall cost may then be calculated as the sum of all those costs.

5) Calculating Random Accesses and Caching Effects

A crucial part in calculating the cost of most data structures is capturing random memory access costs (e.g., the cost of fetching nodes while traversing a tree, fetching nodes linked in a hash bucket, etc.). If data is expected to be cold, then this is a rather straightforward case—i.e., various embodiments may assign the maximum cost that a random access is expected to incur on the target machine. If data may be hot, it is a more involved scenario. For example, in a tree-like structure, internal nodes higher in the tree are much more likely to be at higher levels of the memory hierarchy during repeated requests. Such costs may be computed using the random memory access primitive. For example, referring again to FIG. 4, the input is a “region size,” which is best thought of as the amount of memory that is randomly accessed (i.e., the memory region in which the pointer points to is unknown). The primitive may be trained via benchmarking access to an increasingly bigger contiguous array (step 412). The results (step 414) depict a minor jump from L1 to L2 (a small bump after 10⁴ elements is observed). The bump from L2 to L3 is much more noticeable, with the cost of accessing memory going from 0.1×10⁷ seconds to 0.3×10⁷ seconds, as the memory size crosses the 128 KB boundary. Similarly, a bump from 0.3×10⁷ seconds to 1.3×10⁷ seconds is observed going from L3 to main memory (at the L3 cache size of 16 MB). This behavior is captured as a sum of sigmoidal functions (step 416), which are essentially smoothed step functions, using:

$$c ( x ) = {\sum }_{i = 1}^{k} f ( x ) = {\sum }_{i = 1}^{k} \frac{{c}_{i}}{1 + {e}^{- {k}_{i} ( lo g x - {x}_{i} )}} + {y}_{0} .$$

This primitive may be used to calculate random access to any physical or logical region (e.g., a sequence of nodes that may be cached together). For example, when traversing a tree, various embodiments need to access at Level x of a tree for every node and account for a region size that includes all data in all levels of the tree up to Level x. In this way, accessing a node higher in the tree costs less than a node at lower levels. The same is true when accessing buckets of a hash table. A detailed step by step example is further described below.

6) Example: Cache-Aware Cost Synthesis

In various embodiments, a B-tree-like specification is assumed as follows: two node types, one for internal nodes and one for leaf nodes. Internal nodes containing fence pointers are sorted, balanced, have a fixed fanout of 20, and do not contain any keys or values. Leaf nodes instead are terminal; they include both keys and values and are sorted, have a maximum page size of 250 records, and follow a full columnar format, where keys and values are stored in independent arrays. The test dataset consists of 10⁵ records where keys and values are 8 bytes each. Overall, this indicates that there are 400 full data pages, and thus a tree of height 2. Embodiments of the present invention need two of its access primitives to calculate the cost of a Get operation. Every Get query may be routed through two internal nodes and one leaf node: within each node, it needs to binary search (through fence pointers for internal nodes and through keys in leaf nodes) and thus it may make use of the Sorted Search access primitive. In addition, as a query traverses the tree, it needs to perform a random access for every hop.

In various embodiments, the Sorted Search primitive takes as input the size of the area over which various embodiments perform a binary search and the number of keys. The Random Access primitive may take as input the size of the path so far which allows caching effects to be considered. Each query may start by visiting the root node. Various embodiments then estimate the size of the path so far to be 312 bytes. This is because the size of the path so far is in practice equal to the size of the root node which, containing 20 pointers (because the fanout is 20) and 19 values, sums up at root=internalnode=20×8+19×8=312 bytes. In this way, various embodiments log a cost of RandomAccess(312) to access the root node and then calculate the cost of binary search across 19 fences, thereby logging a cost of SortedSearch(RowStore, 19×8). The “RowStore” option is utilized as fences and pointers are stored as pairs within each internal node. The access to the root node is now fully accounted for, and an embodiment of the present invention moves on to cost the access at the next tree level. Further, the size of the path so far is given by accounting for the whole next level in addition to the root node. This is in total level2=root+fanout×internalnode=312+20×312=6552 bytes (due to fanout being 20, 20 nodes are accounted for at the next level). Thus to access the next node, an embodiment logs a cost of RandomAccess(6552) and again a search cost of SortedSearch(RowStore, 19×8) to search this node. The last step is to search the leaf level. The size of the path so far is given by accounting for the whole size of the tree, which is level2+400×(250×16)=1606552 bytes, since there are 400 pages at the next level (20×20) and each page has 250 records of key-value pairs (8 bytes each). In this way, an embodiment logs a cost of RandomAccess(1606552) to access the leaf node, followed by a sorted search of SortedSearch(ColumnStore, 250×8) to search the keys. In one implementation, the “ColumnStore” option is utilized as keys and values are stored separately in each leaf in different arrays. Finally, a cost of RandomAccess(2000) may be incurred to access the target value in the values array (there are 8×250=2000 in each leaf).

7) Sets of Operations

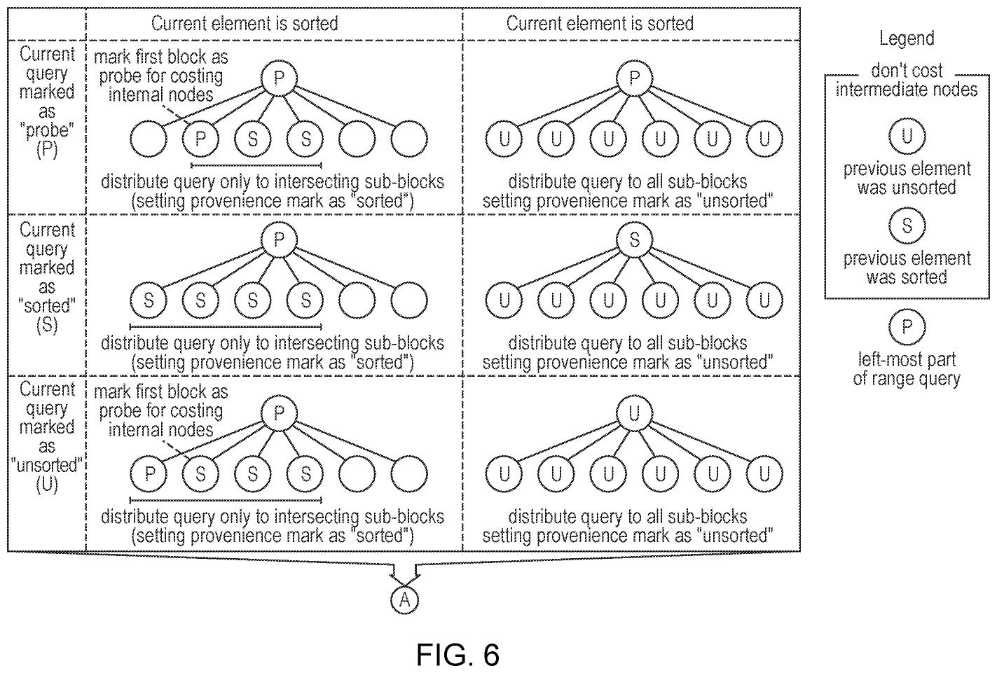

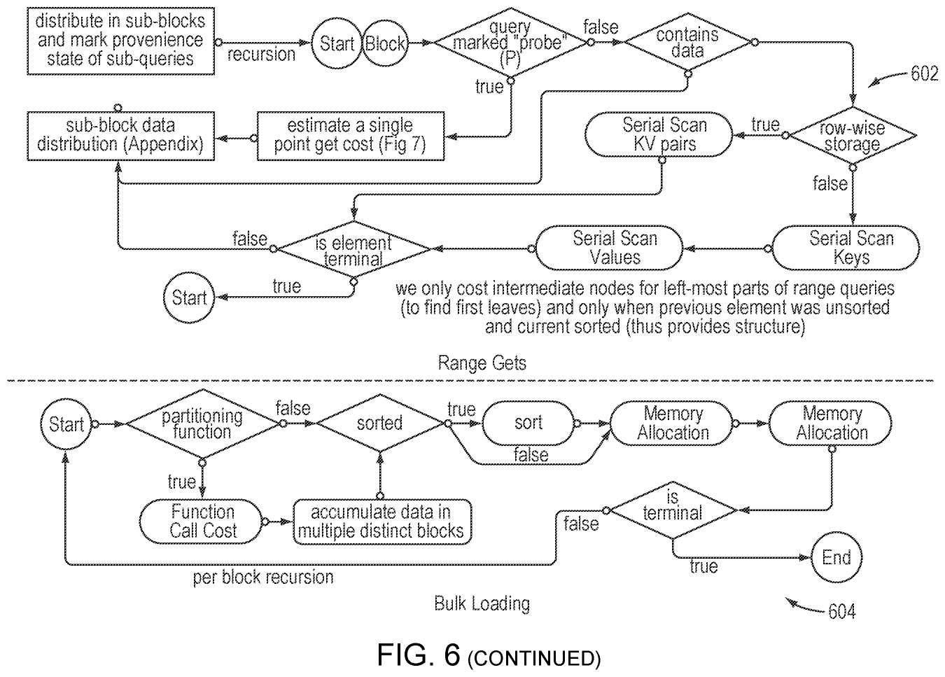

The description above illustrates a single operation only; various embodiments, however, compute the latency for a set of operations concurrently in a single pass. This is effectively the same process as shown in FIG. 5 with only modifications that in every recursion more than one paths are followed and in every step the latency for all queries that may visit a given node is computed. FIG. 6 depicts determination of the cost associated with more operations (e.g., range queries 602 and bulk loading 604 ) using the approaches described above.

8) Workload Skew and Caching Effects

Another parameter that may influence caching effects is workload skew. For example, repeatedly accessing the same path on a data structure results in all nodes in this path being cached with higher probability than others. In various embodiments, counts of how many times every node is going to be accessed for a given workload are first generated. Using these counts and the total number of nodes accessed, a factor p=count/total that denotes the popularity of a node may be computed. Then to calculate the random access cost to a node for an operation k, various embodiments apply a weight w=1/(p×sid), where sid represents the sequence number of this operation in the workload (refreshed periodically). Frequently accessed nodes may see smaller access costs and vice versa.

9) Training Primitives

In various embodiments, all access primitives are trained on warm caches (i.e., caches having files stored therein). This is because they are used to calculate the cost on a node that is already fetched. The only special case may be the Random Access primitive that is used to calculate the cost of fetching a node. This is also trained on warm data, though, since the cost synthesis infrastructure takes care at a higher level to pass the right region size as discussed; in the case this region is big, this can still result in having a cost associated with a page fault as large data will not fit in the cache; this is reflected in the Random Access primitive model.

10) Extensibility and Cross-Pollination

The implementation of having two Levels of access primitives in the systems and approaches described herein is threefold. First, it brings a level of abstraction, allowing higher level cost synthesis algorithms to operate at Level 1 only. Second, it brings extensibility, i.e., the new Level 2 primitives may be added without affecting the overall architecture. Third, it enhances “cross-pollination” of design concepts captured by Level 2 primitives across designs. Thus, when an engineer comes up with a new algorithm to perform search over a sorted array, e.g., exploiting new hardware instructions, she may code up a benchmark for a new sorted search Level 2 primitive and plugs it in the system as shown in FIG. 4 to test whether this can improve performance in her B-tree design, where she regularly searches over sorted arrays. Then the original B-tree design can be easily tested with and without the new sorted search across several workloads and hardware profiles without having to undergo a lengthy implementation phase. At the same time, the new primitive can now be considered by any data structure design that contains a sorted array, such as an LSM-tree with sorted runs, a Hash-table with sorted buckets and so on. Various embodiments of the present invention thus allow easy transfer of ideas and optimizations across designs, a process that usually requires a full study for each optimization and target design.

C. What-If Design and Auto-Completion

Because various embodiments provide approaches to synthesize the performance cost of arbitrary designs, thereby allowing for development of algorithms that search the possible design space may be developed, the systems and approaches described herein may advantageously improve the productivity of engineers by quickly iterating over designs and scenarios before committing to an implementation (or hardware). In addition, some embodiments accelerate research by allowing researchers to easily and quickly test completely new ideas. Further, various embodiments develop educational tools that allow for rapid testing of concepts. Finally, the systems and approaches described herein may allow the development of algorithms for offline auto-tuning and online adaptive systems that transition between designs.

1) What-If Design

Design questions may be formed by varying any one of the input parameters, including data structure (layout) specification, hardware profile and workload (data and queries). For example, in an application utilizing a B-tree-like design for a given workload and hardware scenario, the systems and approaches described herein may answer design questions, such as “What would be the performance impact if I change my B-tree design by adding a bloom filter in each leaf?” The user may simply need to give as input the high-level specification of the existing design and estimate the cost twice: once with the original design and once with the bloom filter variation. In both cases, costing should be done with the original data, queries, and hardware profile so the results are comparable. In other words, using the systems and approaches described herein, the user may quickly test variations of data structure designs simply by altering a high level specification, without having to implement, debug, and test a new design. Similarly, by altering the hardware or workload inputs, a given specification may be tested quickly on alternative environments without having to actually deploy code to this new environment. For example, in order to test the impact of new hardware, various embodiments only need to train its Level 2 primitives on this hardware, which is a process that takes a few minutes. Then, one can test the impact this new hardware may have on arbitrary designs by running what-if questions on the systems described herein without having implementations of those designs and without accessing the new hardware.

2) Auto-Completion

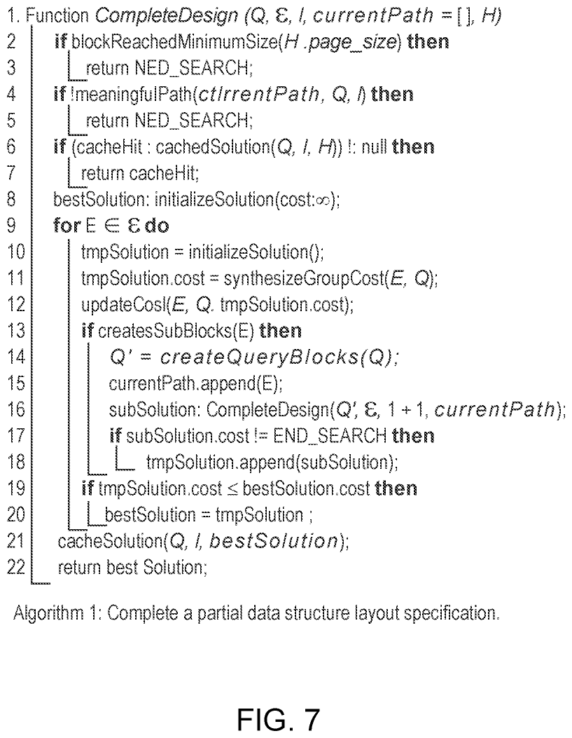

Some embodiments of the present invention complete partial layout specifications given a workload and a hardware profile. The process is shown in FIG. 7: the input is a partial layout specification, data, queries, hardware, and the set of the design space that may be considered as part of the solution, i.e., a list of candidate elements. Starting from the last known point of the partial specification, the rest of the missing subtree of the hierarchy of elements may be computed. At each step, the algorithm considers a new element as a candidate for one of the nodes of the missing subtree and computes the cost for the different kinds of dictionary operations present in the workload. This design may be kept only if it is better than all previous ones, otherwise it may be dropped before the next iteration. The algorithm uses a cache to remember specifications and their costs to avoid recomputation. This process may also be used to tell if an existing design can be improved by marking a portion of its specification as “to be tested.” Solving the search problem completely is an open challenge as the design space is massive. The systems and approaches described herein provide a first step that allows search algorithms to select from a restricted set of elements which are also given as input as opposed to searching the whole set of possible primitive combinations.

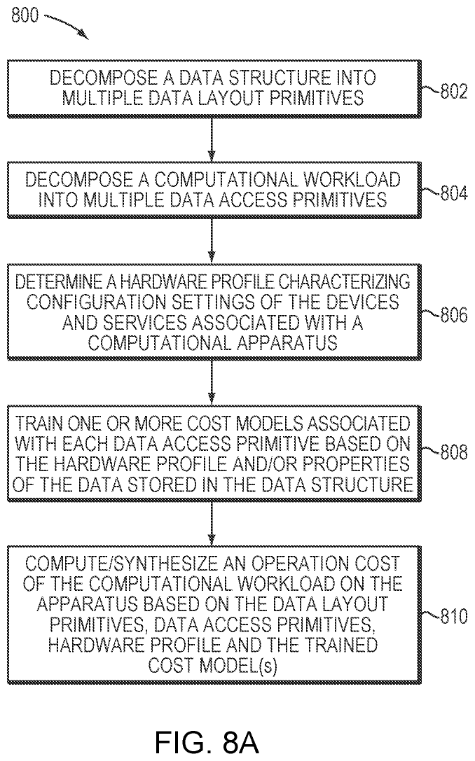

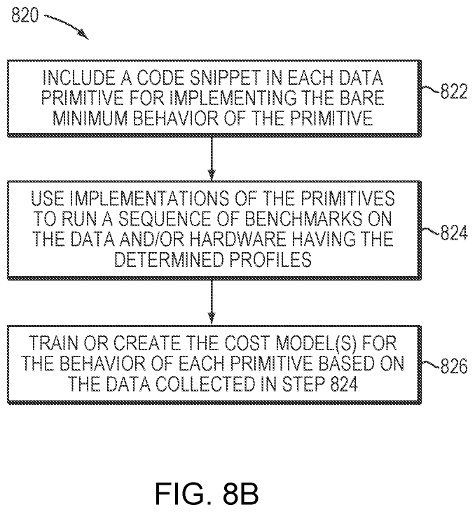

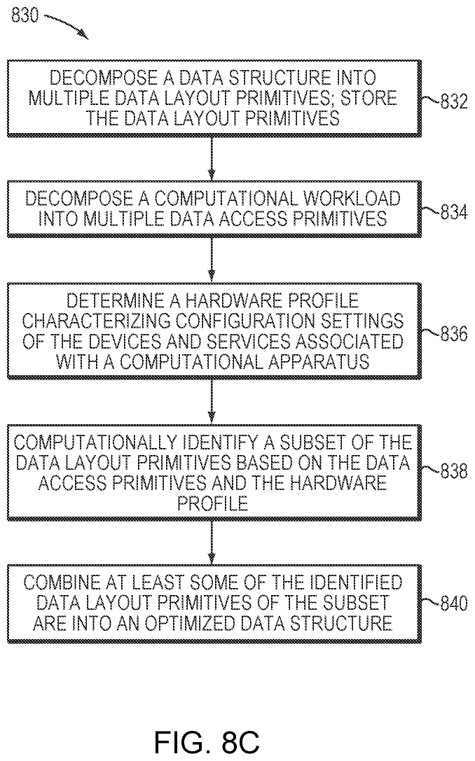

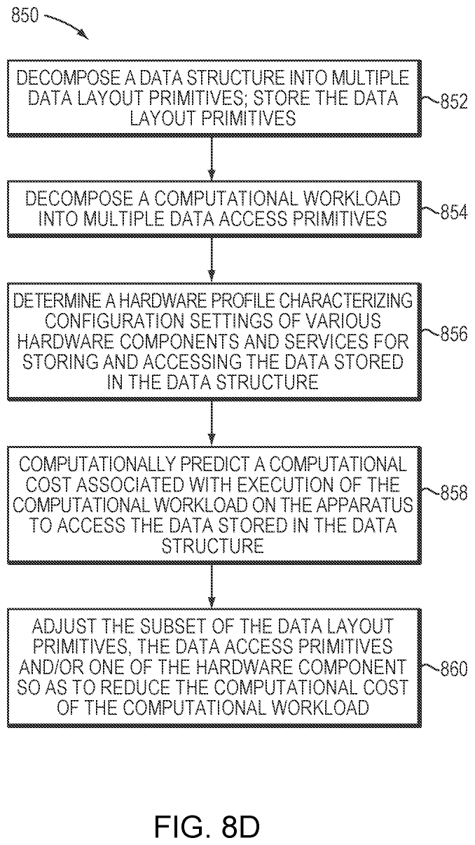

FIG. 8A depicts an exemplary approach 800 for predicting an operation cost of a computational workload on a computational apparatus in accordance with various embodiments. Generally, the workload may access data stored in a data structure. Thus, in the first step 802, the data structure may be decomposed into multiple data layout primitives; each data layout primitive corresponds to a smallest, fundamental layout aspect of the data structure. In a second step 804, the computational workload is decomposed into multiple data access primitives; each access primitive characterizes a computational mechanism for accessing the data stored in the data structure. In one embodiment, the data access primitives are classified into two levels: the first level (Level 1 ) corresponding to an abstract syntax tree having an access pattern and the second level (Level 2 ) corresponding to implementations for accessing the data in the data structure. In a third step 806, a hardware profile characterizing configuration settings of the devices and services associated with the computational apparatus may be determined. In a fourth step 808, one or more cost models associated with each data access primitive may be trained based on the hardware profile and/or properties of the data stored in the data structure. In a fifth step 810, based on the data layout primitives, data access primitives, hardware profile and the trained cost model(s), the operation cost of the computational workload on the apparatus can be computed/synthesized. In one embodiment, the Level 1 access primitives are first used to synthesize operations and then each Level 1 primitive is translated to the appropriate Level 2 primitive to compute the cost of the overall operation.

When the user wants to assess the impact on the operation cost resulting from variation of the data structure design, the user may simply alter the data layout primitives in step 802; the trained cost model(s) may then be applied to predict the updated operation cost (as shown in step 810). Similarly, when the user wants to assess the impact of new hardware and/or new workload on the operation cost, the user need only update the data access primitives based on the new workload (in step 804) and the new hardware profile (in step 806), and cause the cost model(s) associated with the updated Level 2 primitives to be retrained on the new hardware profile (in step 808); subsequently, the updated operation cost can be computed (in step 810).

FIG. 8B depicts an exemplary approach 820 for training or constructing the cost model(s) for each data access primitive in accordance with various embodiments. In a first step 822, each data primitive may include a code snippet that implements the bare minimum behavior of the primitive. In a second step 824, implementations of the primitives may then be used to run a sequence of benchmarks on the data and/or hardware having the determined profiles. In a third step 826, based on the data collected in step 824, the cost model(s) for the behavior of each primitive can be trained or created.

FIG. 8C depicts an exemplary approach 830 for determining an optimized data structure in a computer memory for storing data. In a first step 832, one or more data structures may be decomposed into multiple data layout primitives; the data layout primitives may then be stored in the computer memory or other storage devices. In a second step 834, a computational workload may be decomposed into multiple data access primitives. In a third step 836, a hardware profile characterizing configuration settings of the devices and services associated with the computational apparatus may be determined. In a fourth step 838, based on the data access primitives and the hardware profile, a subset of the data layout primitives may be computationally identified. In a fifth step 840, at least some of the identified data layout primitives of the subset are combined into the optimized data structure such that execution of the computational workload on the apparatus to access the data stored in the optimized data structure has a lowest computational cost among all possible combinations of the data layout primitives into data structures.

FIG. 8D depicts an exemplary approach 850 for reducing the operation cost associated with a computational workload. In a first step 852, one or more data structures may be decomposed into multiple data layout primitives; the data and data layout primitives may then be stored in the computer memory or other storage devices. In a second step 854, a computational workload may be decomposed into multiple data access primitives. In a third step 856, a hardware profile characterizing configuration settings of various hardware components and services for storing and accessing the data stored in the data structure may be determined. In a fourth step 858, a computational cost associated with execution of the computational workload on the apparatus to access the data stored in the data structure may be computationally predicted. In one embodiment, the prediction is achieved using a cost predictor that has been computationally trained to predict computational costs associated with executing each of the data access primitives on subsets of the hardware components to access subsets of the data layout primitives. In a fifth step 860, based on the predicted computational cost and the trained cost predictor, the subset of the data layout primitives, the data access primitives and/or one of the hardware component may be adjusted for reducing the computational cost of the computational workload.

### D. Experimental Analysis

1) Implementation

The core of an embodiment of the invention was coded in C++. This includes the expert systems that handle layout primitives and cost synthesis. A separate module was implemented in Python to analyze benchmark results of Level 2 access primitives and generating the learned models. The benchmarks of Level 2 access primitives were also implemented in C++ such that the learned models can capture performance and hardware characteristics that would affect a full C++ implementation of a data structure. The learning process for each Level 2 access primitive occurs each time a new hardware profile is included; then, the learned coefficients for each model are passed to the C++ back-end to be used for cost synthesis during design questions. For learning, a standard loss function, e.g., least square errors, may be used, and the actual process is done via standard optimization libraries, e.g., SciPy's curve fit. For models that have non-convex loss functions, such as the sum of sigmoids model, good initial parameters are straightforwardly (e.g., algorithmically) set up.

2) Accurate Cost Synthesis

In the first experiment, the ability to accurately determine a cost corresponding to arbitrary data structure specifications across different machines was tested. To do this, the cost generated automatically by the approaches described above was compared with the cost observed when testing a full implementation of a data structure. The experiment was set up as follows. To test with the approaches, data structure specifications for eight well known access methods, including Array, Sorted Array, Linked-list, Partitioned Linked-list, Skip-list, Trie, Hash-table, and B+tree, were written manually. The system described herein then generated the design of operations for each data structure and computed their latency given a workload. To verify the results against an actual implementation, all data structures above were implemented. In addition, algorithms for each of their basic operations: Get, Range Get, and Bulk Load and Update were implemented. The first experiment then started with a data workload of 10⁵ uniformly distributed integers and a sequence of 10² Get requests, also uniformly distributed. More data was then incrementally inserted up to a total of 10⁷ entries and the query workload was repeated at each step.

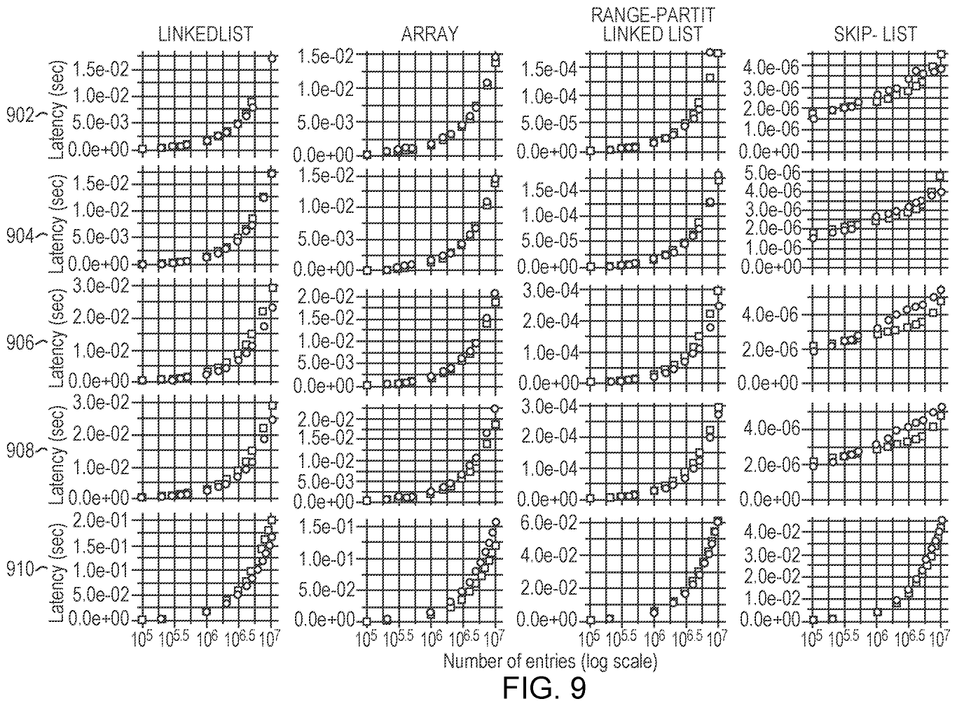

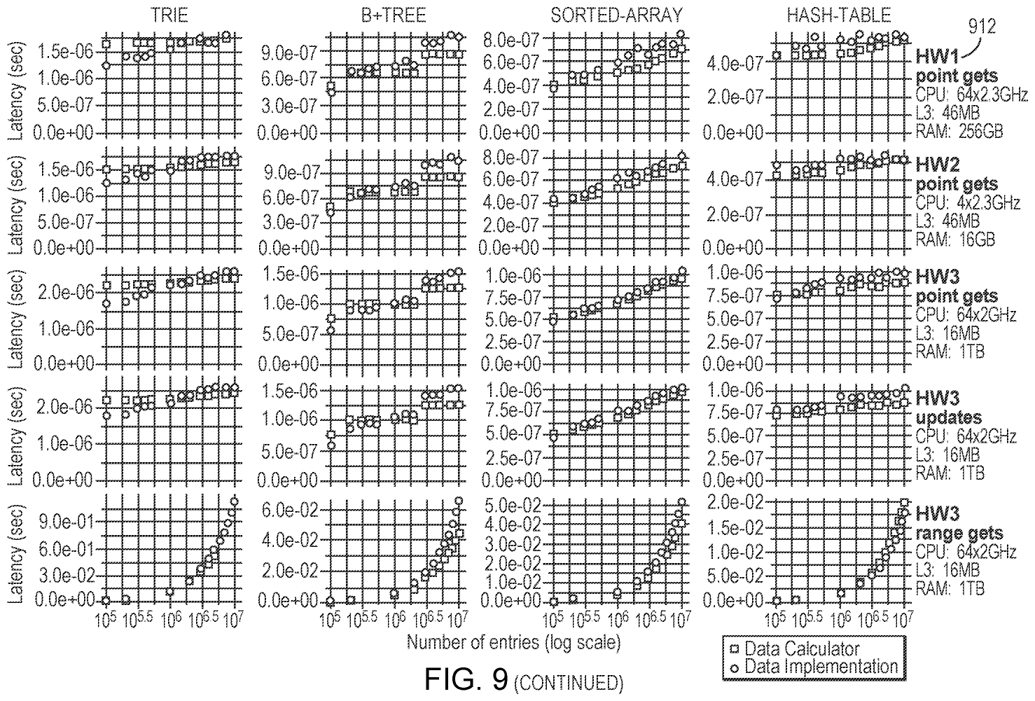

The top row 902 of FIG. 9 depicts results using a machine with 64 cores and 264 GB of RAM. It shows the average latency per query as data grows as computed using the approaches described herein and as observed when running the actual implementation on this machine. For ease of presentation, results are ranked horizontally from slower to faster (left to right). The approaches described herein gave an accurate estimation of the cost across the whole range of data sizes and regardless of the complexity of the designs both in terms of the data structure. The approaches described herein can accurately compute the latency of both simple traversals in a plain array and the latency of more complex access patterns, such as descending a tree and performing random hops in memory.

3) Diverse Machines and Operations

The rest of the rows 904-910 in FIG. 9 repeated the same experiment as above using different hardware in terms of CPU and memory properties (Rows 904 and 906 ) and different operations (Rows 908 and 910). The details of the hardware are shown on the right side 912 of each row in FIG. 9. Regardless of the machine or operation, the approaches described herein can accurately determine a cost of any design. By training its Level 2 primitives on individual machines and maintaining a profile for each one of them, the approaches described herein can quickly test arbitrary designs over arbitrary hardware and operations. Updates here were simple updates that change the value of a key-value pair and so they were effectively the same as a point query with an additional write access.

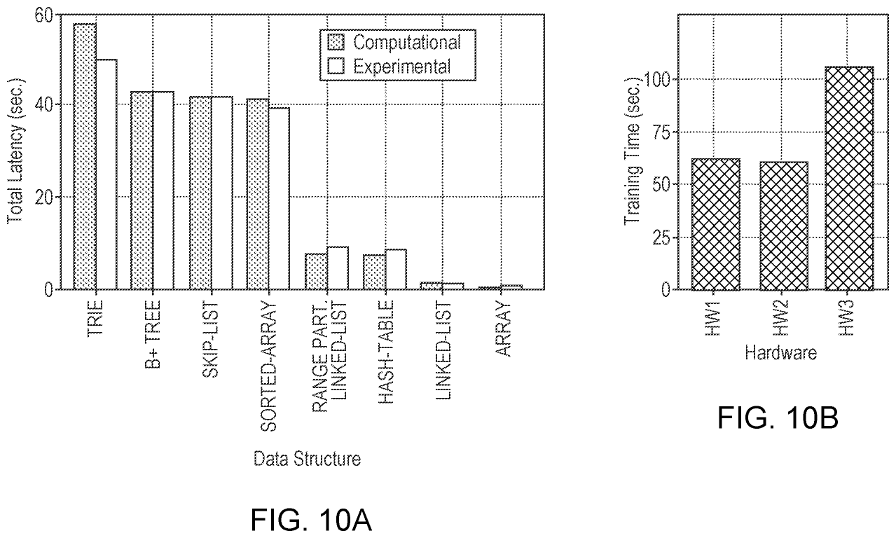

Finally, FIG. 10A depicts that the approaches described herein can accurately synthesize the bulk loading costs for all data structures. FIG. 10B depicts the time needed to train all Level 2 primitives on a diverse set of machines. Overall, this was an inexpensive process—it took merely a few minutes to train multiple different combinations of data and hardware profiles.

4) Cache Conscious Designs and Skew

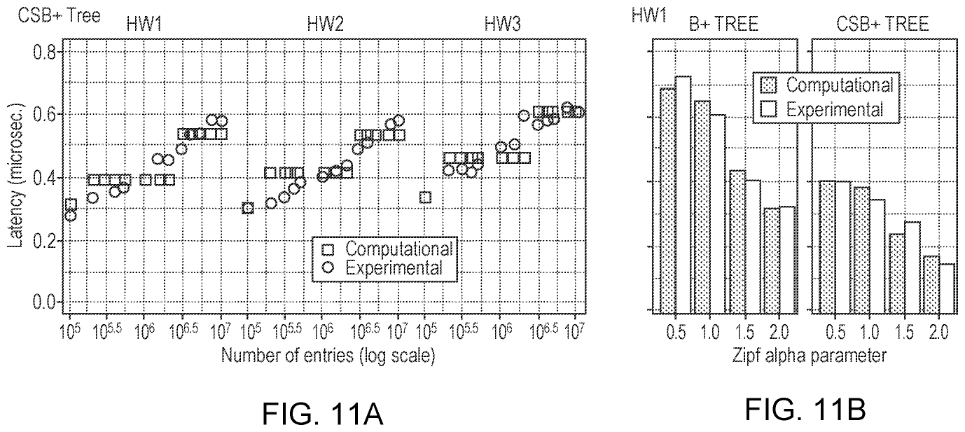

In addition, the base fitting experiment was repeated using a cache-conscious design, Cache Conscious B+tree (CSB). FIG. 11A depicts that the approaches described herein accurately predicted the performance behavior across a diverse set of machines, capturing caching effects of growing data sizes and design patterns where the relative position of nodes affected tree traversal costs. The “Full” design from Cache Conscious B+tree was used. Further, FIG. 10B tested the fitting when the workload exhibits skew. For this experiment Get queried where generated with a Zipfian distribution: α={0.5, 1.0, 1.5, 2.0}. FIG. 11B shows that for the implementation results, workload skew improved performance and in fact it improved more for the standard B+tree. This is because the same paths are more likely to be taken by queries resulting in these nodes being cached more often. Cache Conscious B+tree improved but at a much slower rate as it was already optimized for the cache hierarchy. The approaches described herein can thus synthesize these costs accurately, capturing skew and the related caching effects.

5) Rich Design Questions

The next experiment was designed to provide insights about the kinds of design questions possible and how long they may take, working over a B-tree design and a workload of uniform data and queries: 1 million inserts and 100 point Gets. The hardware profile used was HW1 (defined in FIG. 9). The user asked “What if we change our hardware to HW3?”. It took the system only 20 seconds (all runs are done on HW3) to compute that the performance would drop. The user then asked “Is there a better design for this new hardware and workload if we restrict search on a specific set of five possible elements?” (from the pool of FIG. 1C). It took only 47 seconds for the system to compute the best choice. The user then asked “Would it be beneficial to add a bloom filter in all B-tree leaves?” The approaches described herein computed in merely 20 seconds that such a design change would be beneficial for the current workload and hardware. The next design question was: “What if the query workload changes to have skew targeting just 0.01% of the key space?” The approaches described herein computed in 24 seconds that this new workload would hurt the original design and they computed a better design in another 47 seconds.

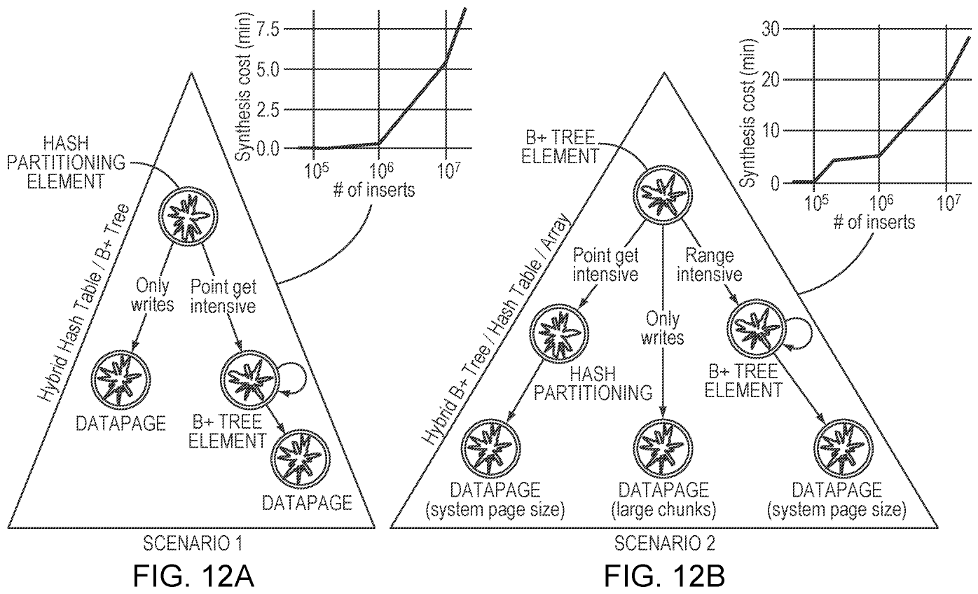

In two of the design phases, the user asked “give me a better design if possible.” More intuition can be provided for this kind of design question regarding the cost and scalability of computing such designs as well as the kinds of designs the approaches described herein may produce to fit a workload. Two scenarios were tested for a workload of mixed reads and writes (uniformly distributed inserts and point reads) and hardware profile HW 3. In the first scenario, all reads were point queries in 20% of the domain. In the second scenario, 50% of the reads were point reads and touch 10% of the domain, while the other half were range queries and touched a different (non-intersecting with the point reads) 10% of the domain. The system was not provided with an initial specification. Given the composition of the workload, a mix of hashing, B-tree like indexing (e.g., with quantile nodes and sorted pages), and a simple log (unsorted pages) was expected to lead to a good design; thus the system was instructed to use those four elements to construct a design (this was done using Algorithm 1 but starting with an empty specification. FIGS. 12A and 12B depict the specifications of the resulting data structures. For the first scenario (FIG. 12A), the approaches described herein computed a design where a hashing element at the upper levels of the hierarchy allowed to quickly access data but then data was split between the write and read intensive parts of the domain to simple unsorted pages (like a log) and B+tree -style indexing for the read intensive part. For the second scenario (FIG. 12B), the approaches described herein produced a design that similarly to the previous one took care of read and writes separately, but this time also distinguished between range and point gets by allowing the part of the domain that received point queries to be accessed with hashing and the rest via B+tree style indexing. The time needed for each design question was in the order of a few seconds up to 30 minutes, depending on the size of the sample workload (the synthesis costs are embedded in FIGS. 12A and 12 B for both scenarios). Thus, the approaches described herein quickly answered complex questions that would normally take humans days or even weeks to test fully.

E. Related Work

1) Interactive Design

One of the conventional data structure designs, Magic, uses a set of design rules to quickly verify transistor designs so they can be simulated by designers. In other words, a designer may propose a transistor design and Magic will determine if this is correct or not. Naturally, this is a huge step especially for hardware design where actual implementation is extremely costly. The systems and approaches described herein push interactive design one step further to incorporate cost estimation as part of the design phase by being able to estimate the cost of adding or removing individual design options which in turn also allows the designer to build design algorithms for automatic discovery of good and bad designs instead of having to build and test the complete design manually.

2) Generalized Indexes

Another conventional data structure design, Generalized Search Tree Indexes (GiST), aims to make it easy to extend data structures and tailor them to specific problems and data with minimal effort. It is a template, an abstract index definition that allows designers and developers to implement a large class of indexes. The original proposal focused on record retrieval only but later work added support for concurrency, a more general API, improved performance, selectivity estimation on generated indexes and even visual tools that help with debugging. While the approaches described herein and GiST share motivation, they are fundamentally different: GiST is a template to implement tailored indexes while the approaches described herein is an engine that computes the performance of a design enabling rich design questions that compute the impact of design choices before the user starts coding, making these two lines of work complementary.

3) Modular/Extensible Systems and System Synthesizers

A key part of various embodiments of the present invention is its design library, breaking down a design space in components and then being able to use any set of those components as a solution. As such various embodiments share concepts with the stream of work on modular systems, an idea that has been explored in many areas of computer science: in databases for easily adding data types with minimal implementation effort, or plug and play features and whole system components with clean interfaces, as well as in software engineering, computer architecture, and networks. Since for every area the output and the components are different, there are particular challenges that have to do with defining the proper components, interfaces and algorithms. The concept of modularity is similar in the context of various embodiments of the present invention. The goal and application of the concept, however, is completely different.

In sum, the present invention allows researchers and engineers to interactively and semi-automatically navigate complex design decisions when designing or re-designing data structures, considering new workloads and hardware using a new paradigm of first principles of data layouts and learned cost models. The design space presented here includes basic layout primitives and primitives that enable cache conscious designs by dictating the relative positioning of nodes, focusing on read only queries. The quest for the first principles of data structures needs to continue to find the primitives for additional significant classes of designs, including updates, compression, concurrency, adaptivity, graphs, spatial data, version control management, and replication. Such steps may also require new innovations for cost synthesis and verification of designs as every major class of design brings new challenges but at the same time for every design class added (or even for every single primitive added), the knowledge gained in terms of the possible data structures designs grows exponentially. Additional opportunities include full DSLs for data structures that go beyond the high-level specification presented here, new classes of adaptive systems that can change their core design on-the-fly, and machine learning algorithms that can search the whole design space.

F. Representative Architecture

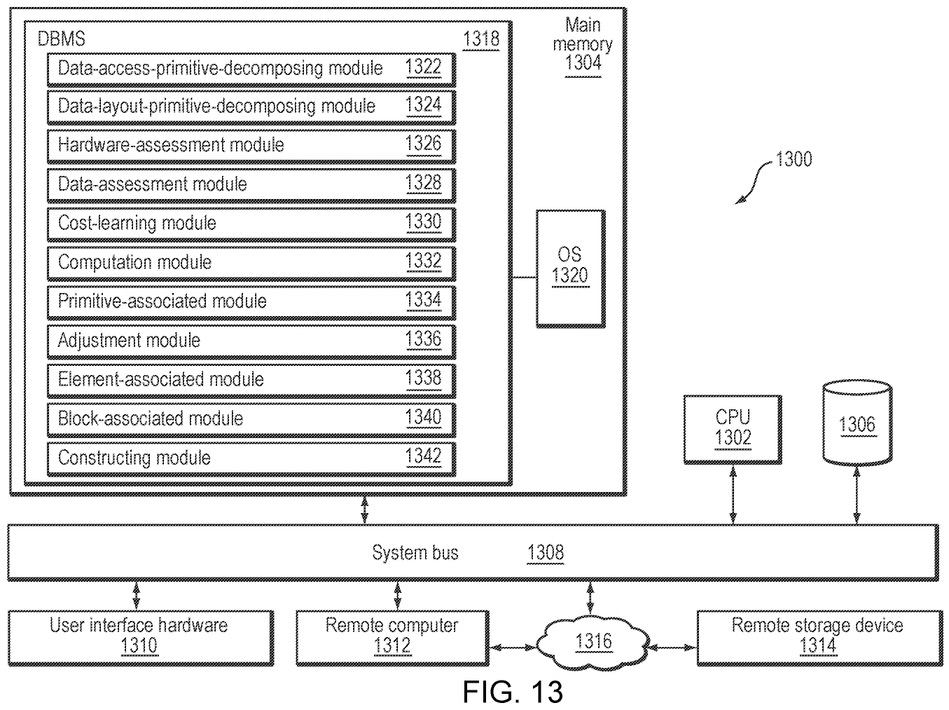

Approaches for determining an operation cost of a computational workload that accesses data stored in a data structure in a computational apparatus in accordance herewith can be implemented in any suitable combination of hardware, software, firmware, or hardwiring. FIG. 13 illustrates an exemplary embodiment utilizing a suitably programmed general-purpose computer 1300. The computer includes a central processing unit (CPU) 1302, at least a main (volatile) memory 1304 and non-volatile mass storage devices 1306 (such as, e.g., one or more hard disks and/or optical storage units) for storing various types of files. The main memory 1304 and/or storage devices 1306 may store data in a data structure. The computer 1300 further includes a bidirectional system bus 1308 over which the CPU 1302, main memory 1304, and storage devices 1306 communicate with each other and with internal or external input/output devices, such as traditional user interface components 1310 (including, e.g., a screen, a keyboard, and a mouse) as well as a remote computer 1312 and/or a remote storage device 1314 via one or more networks 1316. The remote computer 1312 and/or storage device 1314 may transmit any information (e.g., a computational workload) to the computer 1300 using the network 1316.

In some embodiments, the computer 1300 includes a database management system (DBMS) 1318, which itself manages reads and writes to and from various tiers of storage, including the main memory 1304 and secondary storage devices 1306. The DBMS establishes, and can vary, primitives (e.g., the data layout primitives and/or the data access primitives) as described above. The DBMS 1318 may be implemented by computer-executable instructions (conceptually illustrated as a group of modules and stored in main memory 1304) that are executed by the computer 1300 so as to control the operation of CPU 1302 and its interaction with the other hardware components.

In addition, an operating system 1320 may direct the execution of low-level, basic system functions such as memory allocation, file management and operation of the main memory 1304 and/or mass storage devices 1306. At a higher level, one or more service applications provide the computational functionality required for implementing the operation-cost prediction approaches based on the data layout primitives, data access primitives and hardware profile described herein. For example, as illustrated, upon receiving a computational workload from a user via the user interface 1310 and/or from an application in the remote computer 1312 and/or the computer 1300, the system 1320 may assess a data-access-primitive-decomposing module 1322 stored in the main memory 1304 and/or secondary storage devices 1306 to decompose the received workload into one or more data access primitives. In one embodiment, the data-access-primitive-decomposing module 1322 classifies the data access primitives into two levels, Level 1 and Level 2 described above. In addition, the system 1320 may include a data-layout-primitive-decomposing module 1324 to identify a data structure that stores the data required by the received workload in the memory 1304 and/or secondary storage devices 1306 and decompose the data structure into one or more data layout primitives. In one embodiment, the system includes a hardware-assessment module 1326 to determine the hardware profile characterizing configuration settings of the devices and services associated with the computer 1300. In addition, the system may include a data-assessment module 1328 that determines the properties of the data stored in the data structure. Further, the system may include a cost-learning module 1330 that trains one or more cost models associated with each data access primitive based on the hardware profile and/or data properties. For example, the cost-learning module 1330 may include a code snippet in each data primitive for implementing the bare minimum behavior of the primitive. In addition, the cost-learning module 1330 may use implementations of the primitives to run a sequence of benchmarks on the data and/or hardware, and based on the data collected therefrom, train or create the cost model(s) for the behavior of each primitive. In one embodiment, the system includes a computation module 1332 for computing/synthesizing the operation cost of the computational workload on the computer 1300 based on the data layout primitives, data access primitives, hardware profile, data properties, and/or the trained cost model(s). In addition, the system may include a primitive-associated module 1334 for identifying a subset of the data layout primitives based on the data access primitives and the hardware profile. The primitive-associated module 1334 may then combine the identified subset of the data layout primitives into an optimized data structure such that execution of the computational workload on the apparatus to access the data stored in the optimized data structure has a lowest computational cost among all possible combinations of the data layout primitives into data structures. In one embodiment, the system further includes an adjustment module 1336 for adjusting the subset of the data layout primitives, the data access primitives and/or one of the hardware component so as to reduce the computational cost of the computational workload.

In various embodiments, the DBMS further includes an element-associated module 1338 for defining multiple data structure elements that represent the full specifications of the data structure nodes. In addition, the element-associated module 1338 may create one or more complex hierarchies of the defined data structure elements for synthesizing the data structure designs. In one embodiment, the DBMS includes a block-associated module 1340 for defining a logical portion of the data that can be divided into smaller blocks for constructing an instance of the data structure specification. The element-associated module 1338 and/or block-associated module 1340 may then apply the data structure elements recursively onto blocks for constructing data structure instances. Finally, the system may include a constructing module 1342 for constructing the design space based on the data layout primitives, data structure elements and blocks as described above.

Generally, program modules 1322-1342 include routines, programs, objects, components, data structures, etc. that performs particular tasks or implement particular abstract data types. Those skilled in the art will appreciate that the invention may be practiced with various computer system configurations, including multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

In addition, the CPU 1302 may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/ 2 operating system, the BeOS operating system, the MACINTOSH operating system, the APACHE operating system, an OPENSTEP operating system or another operating system of platform.

The CPU 1302 that executes commands and instructions may be a general-purpose processor, but may utilize any of a wide variety of other technologies including special-purpose hardware, a microcomputer, mini-computer, mainframe computer, programmed micro-processor, micro-controller, peripheral integrated circuit element, a CSIC (customer-specific integrated circuit), ASIC (application-specific integrated circuit), a logic circuit, a digital signal processor, a programmable logic device such as an FPGA (field-programmable gate array), PLD (programmable logic device), PLA (programmable logic array), smart chip, or any other device or arrangement of devices that is capable of implementing the steps of the processes of the invention.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

More generally, the computer shown in FIG. 13 is representative only and intended to provide one possible topology. It is possible to distribute the functionality illustrated in FIG. 13 among more or fewer computational entities as desired. The network 1916 may include a wired or wireless local-area network (LAN), wide-area network (WAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI, for example. For wireless communications, communications protocols may include the cellular telecommunications infrastructure, WiFi or other 802.11 protocol, Bluetooth, Zigbee, IrDa or other suitable protocol. Furthermore, components of the system may communicate through a combination of wired or wireless paths.

Any suitable programming language may be used to implement without undue experimentation the analytical functions described within. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript for example. Further, it is not necessary that a single type of instruction or programming language be utilized in conjunction with the operation of the system and method of the invention. Rather, any number of different programming languages may be utilized as is necessary or desirable.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. An apparatus for determining an operation cost of a computational workload, the apparatus comprising:
a computer memory for storing data in a data structure; and
a computer processor configured to:
decompose the data structure into a plurality of data layout primitives, each data layout primitive corresponding to a smallest, fundamental layout aspect of the data structure;
decompose the computational workload into a plurality of data access primitives, each data access primitive corresponding to a computational mechanism for accessing the data stored in the data structure;
determine a hardware profile associated with the apparatus; and
compute the operation cost of the computational workload on the apparatus based at least in part on the data layout primitives, the data access primitives, and the hardware profile.

2. The apparatus of claim 1, further comprising an interface for receiving an input updating at least one of the data layout primitives, computational workload and/or hardware profile, wherein the computer processor is further configured to update the operation cost based on the input.

3. The apparatus of claim 1, wherein the computer processor is further configured to classify the data layout primitives into a plurality of classes comprising one or more of node organization, node filters, partitioning, node physical placement or node metadata management.

4. The apparatus of claim 1, wherein the computer processor is further configured to classify the data access primitives into two levels comprising (i) a first level corresponding an abstract syntax tree having an access pattern and (ii) a second level corresponding to implementations for accessing the data in the data structure.

5. The apparatus of claim 4, wherein the first level comprising a scan primitive, a sorted search primitive, a hash probe primitive, a Bloom filter probe primitive, a sort primitive, a random memory access primitive, a batched random memory access primitive, a unordered batch write primitive, an ordered batch write primitive and a scattered batch write primitive.

6. The apparatus of claim 4, wherein the computer processor is further configured to synthesize at least some of the first-level data access primitives, translate the synthesized data access primitives to corresponding second-level data access primitives and compute the operation cost based on the corresponding second-level data access primitives.

7. The apparatus of claim 1, wherein the computer processor is further configured to computationally train one or more cost models associated with each data access primitive based on at least one of the hardware profile or data properties.

8. The apparatus of claim 7, wherein the computer processor is further configured to synthesize costs associated with the data access primitives based at least in part on the one or more models.

9. The apparatus of claim 7, wherein the one or more cost models are parametric models.

10-23. (canceled)

24. A method of determining an operation cost of a computational workload, the computation workload being executed on a computational apparatus and accessing data stored in a data structure therein, the method comprising:
decomposing the data structure into a plurality of data layout primitives, each data layout primitive corresponding to a smallest, fundamental layout aspect of the data structure;
decomposing the computational workload into a plurality of data access primitives, each data access primitive corresponding to a computational mechanism for accessing the data stored in the data structure;
determining a hardware profile associated with the apparatus; and
computing the operation cost of the computational workload on the apparatus based at least in part on the data layout primitives, the data access primitives, and the hardware profile.

25. The method of claim 24, further comprising:
receiving an input updating at least one of the data layout primitives, computational workload and/or hardware profile; and
updating the operation cost based on the input.

26. The method of claim 24, further comprising classifying the data layout primitives into a plurality of classes comprising one or more of node organization, node filters, partitioning, node physical placement or node metadata management.

27. The method of claim 24, further comprising classifying the data access primitives into two levels comprising (i) a first level corresponding an abstract syntax tree having an access pattern and (ii) a second level corresponding to implementations for accessing the data in the data structure.

28. The method of claim 27, wherein the first level comprising a scan primitive, a sorted search primitive, a hash probe primitive, a Bloom filter probe primitive, a sort primitive, a random memory access primitive, a batched random memory access primitive, a unordered batch write primitive, an ordered batch write primitive and a scattered batch write primitive.

29. The method of claim 27, further comprising synthesizing at least some of the first-level data access primitives, translating the synthesized data access primitives to corresponding second-level data access primitives and computing the operation cost based on the corresponding second-level data access primitives.

30. The method of claim 24, further comprising computationally training one or more cost models associated with each data access primitive based on at least one of the hardware profile or data properties.

31. The method of claim 30, further comprising synthesizing costs associated with the data access primitives based at least in part on the one or more models.

32. The method of claim 30, wherein the one or more cost models are parametric models.

33-46. (canceled)
